(19) United States
(12) Patent Application Publication
(10) Pub. No.: US 2026/0339346 A1
(43) Pub. Date: Oct. 29, 2026

(54) Fiducial-Based Post-Landing Verification For Drone Docking

(71) Applicant: Skydio, Inc., San Mateo, CA (US)

(72) Inventors: Divyanshu Pachisia, San Francisco, CA (US); Maximilian Joseph Halper Krogius, San Mateo, CA (US); Parth Oza, San Mateo, CA (US); Shreetej Varakantam Reddy, San Mateo, CA (US); Davide Falanga, Sunnyvale, CA (US); Kristen Marie Holtz, Menlo Park, CA (US); Patrick Allen Lowe, Palo Alto, CA (US); Ryan Brott, San Mateo, CA (US); Peter Benjamin Henry, San Francisco, CA (US); Quentin Allen Wah Yen Delepine, Cupertino, CA (US)

(21) Appl. No.: 19/656,335

(22) Filed: Apr. 23, 2026

Related U.S. Application Data
(60) Provisional application No. 63/793,074, filed on Apr. 23, 2025.

(51) Int. Cl. G05D 1/661; B64F 1/02; G05D 1/244; G06T 7/70; G05D 109/20; G05D 111/10

(52) U.S. Cl. CPC G05D 1/661; B64F 1/02; G05D 1/244; G06T 7/70; G05D 2109/20; G05D 2111/10; G06T 2207/10032; G06T 2207/30204

(57) ABSTRACT

A system for drone docking includes a docking station comprising a landing platform configured to receive an unmanned aerial vehicle and a fiducial marker array disposed on the landing platform comprising a plurality of fiducial markers. A docking mechanism is configured to engage the unmanned aerial vehicle when positioned on the landing platform. A navigation camera mounted on the unmanned aerial vehicle captures image data of the fiducial marker array after landing. A post-landing visual confirmation system detects one or more fiducial markers in the image data, determines a pose of the unmanned aerial vehicle relative to the docking station based on the detected fiducial markers, determines whether the pose is within acceptable alignment parameters, and generates an engagement authorization signal to permit engagement of the docking mechanism when the pose is within the acceptable alignment parameters.

### CROSS-REFERENCE TO RELATED APPLICATIONS

This claims priority to and benefit from U.S. Provisional Patent Application No. 63/793,074, filed on Apr. 23, 2025 titled “FIDUCIAL MARKER ARRAY SYSTEM FOR DRONE DOCKING AND RELATED METHODS” which is expressly incorporated by reference herein.

### FIELD OF INVENTION

The present disclosure relates to unmanned aerial vehicle docking systems, and more particularly to fiducial-based post-landing visual verification systems and methods for controlling engagement of a docking mechanism based on a determined pose of an unmanned aerial vehicle relative to a docking station.

### BACKGROUND

Unmanned aerial vehicles have become increasingly prevalent across various industries, including logistics, agriculture, surveillance, and emergency response. As unmanned aerial vehicles become more integral to these operations, the need for efficient and reliable docking solutions has become increasingly apparent. Docking stations may provide landing platforms where unmanned aerial vehicles can touch down, and docking mechanisms may be used to secure, align, charge, or otherwise interface with the unmanned aerial vehicle after landing.

Docking systems may face challenges related to environmental conditions that can affect visibility of visual markers or other features used during landing and docking procedures. For example, snow, water, lighting variations, and occlusions may affect the ability of onboard cameras to detect visual features on a docking station. These conditions may lead to difficulties in determining the position and orientation of an unmanned aerial vehicle relative to a docking station.

In some docking workflows, a docking mechanism may be actuated after touchdown is detected. However, an unmanned aerial vehicle may touch down in a position or orientation that, while stable enough to remain on the landing platform, may not be suitable for engagement of the docking mechanism. Actuating a docking mechanism when an unmanned aerial vehicle is not properly aligned may result in undesirable outcomes, such as pushing the unmanned aerial vehicle out of position or creating conditions that require manual intervention. In some cases, actuation of a docking mechanism when the unmanned aerial vehicle is not properly aligned may itself induce displacement or instability of the unmanned aerial vehicle.

The diversity in unmanned aerial vehicle models and docking station designs may present additional considerations for docking systems. Different unmanned aerial vehicles may have different sizes, landing gear configurations, and camera placements, which may affect how the unmanned aerial vehicle interacts with a docking station. Docking systems that can accommodate various configurations may provide operational flexibility.

Accordingly, there is a general need for docking systems and methods that can address one or more of these considerations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for drone docking is provided. The system includes a docking station comprising a landing platform configured to receive an unmanned aerial vehicle and a fiducial marker array disposed on the landing platform. The fiducial marker array comprises a plurality of fiducial markers. The system includes a docking mechanism configured to engage the unmanned aerial vehicle when the unmanned aerial vehicle is positioned on the landing platform. The system includes a navigation camera mounted on the unmanned aerial vehicle and configured to capture image data of the fiducial marker array after the unmanned aerial vehicle has landed on the landing platform. The system includes a post-landing visual confirmation system configured to detect one or more fiducial markers of the fiducial marker array in the image data captured by the navigation camera, determine a pose of the unmanned aerial vehicle relative to the docking station based on the detected one or more fiducial markers, determine whether the pose is within acceptable alignment parameters, and generate an engagement authorization signal to permit engagement of the docking mechanism, wherein actuation of the docking mechanism is performed when the pose is within the acceptable alignment parameters and actuation is withheld when the pose is not within the acceptable alignment parameters or when the one or more fiducial markers are not detected.

According to other aspects of the present disclosure, the system may include one or more of the following features. The post-landing visual confirmation system may be further configured to generate an engagement inhibit signal to prevent engagement of the docking mechanism when the pose is not within the acceptable alignment parameters. The post-landing visual confirmation system may be further configured to generate an engagement inhibit signal to prevent engagement of the docking mechanism when the one or more fiducial markers are not detected in the image data. The fiducial marker array may comprise fiducial markers of varying sizes, wherein the varying sizes ensure that at least one fiducial marker is detectable by the navigation camera under different conditions. The docking mechanism may further comprise an alignment mechanism configured to center and secure the unmanned aerial vehicle on the landing platform, and the engagement authorization signal may permit actuation of the alignment mechanism. The system may further comprise a communications interface configured to transmit an alert message to a remote operator interface when the pose is not within the acceptable alignment parameters. The post-landing visual confirmation system may be further configured to initiate a retry landing attempt when the pose is not within the acceptable alignment parameters. The docking station may further comprise heating elements configured to improve visibility of the fiducial marker array by melting snow or evaporating water from the landing platform. In some aspects, the post-landing visual confirmation system may process a plurality of image frames captured after landing and determine a confidence metric associated with detection of the one or more fiducial markers, and may permit engagement of the docking mechanism based on the confidence metric.

In some aspects, the alignment mechanism has one or more contact surfaces configured to engage the unmanned aerial vehicle. The system may determine whether the unmanned aerial vehicle is positioned within an engagement region defined relative to the one or more contact surfaces and may permit actuation of the docking mechanism when the unmanned aerial vehicle is positioned within the engagement region. The engagement region may correspond to positions in which actuation results in controlled engagement without inducing displacement or instability of the unmanned aerial vehicle.

According to another aspect of the present disclosure, a method for post-landing verification and docking engagement is provided. The method includes receiving, by a post-landing visual confirmation system, image data captured by a navigation camera mounted on an unmanned aerial vehicle after the unmanned aerial vehicle has landed on a landing platform of a docking station, wherein the landing platform comprises a fiducial marker array. The method includes detecting, by the post-landing visual confirmation system, one or more fiducial markers of the fiducial marker array in the image data. The method includes determining, by the post-landing visual confirmation system, a pose of the unmanned aerial vehicle relative to the docking station based on the detected one or more fiducial markers. The method includes determining, by the post-landing visual confirmation system, whether the pose is within acceptable alignment parameters. The method includes generating, by the post-landing visual confirmation system, an engagement authorization signal to permit engagement of a docking mechanism when the pose is within the acceptable alignment parameters.

According to other aspects of the present disclosure, the method may include one or more of the following features. The method may further comprise generating an engagement inhibit signal to prevent engagement of the docking mechanism when the pose is not within the acceptable alignment parameters. The method may further comprise generating an engagement inhibit signal to prevent engagement of the docking mechanism when the one or more fiducial markers are not detected in the image data. The fiducial marker array may comprise fiducial markers of varying sizes, and detecting the one or more fiducial markers may comprise detecting at least one fiducial marker of the fiducial markers of varying sizes. The method may further comprise transmitting an alert message to a remote operator interface when the pose is not within the acceptable alignment parameters. The method may further comprise initiating a retry landing attempt when the pose is not within the acceptable alignment parameters, wherein initiating the retry landing attempt comprises commanding the unmanned aerial vehicle to take off from the landing platform and attempt landing again. Determining the pose may comprise computing a relative position and orientation of the unmanned aerial vehicle with respect to the docking station based on detected corners of the one or more fiducial markers. Determining whether the pose is within acceptable alignment parameters may comprise comparing at least one of a lateral offset, a rotational offset, or a yaw offset to a corresponding acceptance threshold.

According to another aspect of the present disclosure, a non-transitory computer-readable medium storing instructions is provided. The instructions, when executed by a processor of an unmanned aerial vehicle, cause the processor to receive image data captured by a navigation camera mounted on the unmanned aerial vehicle after the unmanned aerial vehicle has landed on a landing platform of a docking station, wherein the landing platform comprises a fiducial marker array. The instructions cause the processor to detect one or more fiducial markers of the fiducial marker array in the image data. The instructions cause the processor to determine a pose of the unmanned aerial vehicle relative to the docking station based on the detected one or more fiducial markers. The instructions cause the processor to determine whether the pose is within acceptable alignment parameters. The instructions cause the processor to generate an engagement authorization signal to permit engagement of a docking mechanism of the docking station when the pose is within the acceptable alignment parameters.

According to other aspects of the present disclosure, the non-transitory computer-readable medium may include one or more of the following features. The instructions may further cause the processor to generate an engagement inhibit signal to prevent engagement of the docking mechanism when the pose is not within the acceptable alignment parameters or when the one or more fiducial markers are not detected in the image data. The instructions may further cause the processor to transmit an alert message to a remote operator interface and initiate a retry landing attempt when the pose is not within the acceptable alignment parameters. The fiducial marker array may comprise fiducial markers of varying sizes to ensure that at least one fiducial marker is detectable by the navigation camera across different distances and view angles.

According to another aspect of the present disclosure, a docking station configured for controlled engagement of an unmanned aerial vehicle is provided. The docking station includes a docking mechanism configured to engage the unmanned aerial vehicle. The docking station includes an engagement interlock configured to receive an engagement authorization signal generated based on a post-landing determination of a pose of the unmanned aerial vehicle and prevent actuation of the docking mechanism in the absence of the engagement authorization signal.

According to other aspects of the present disclosure, the docking station may include one or more of the following features. The engagement interlock may permit actuation of the docking mechanism only upon receipt of the engagement authorization signal. The engagement interlock may be configured to default to an inhibit state in which actuation of the docking mechanism is prevented. The docking station may further comprise a dock controller configured to control the docking mechanism, wherein the engagement interlock is positioned between the dock controller and the docking mechanism. The engagement interlock may comprise a hardware interlock configured to block actuation signals. The engagement interlock may be configured to inhibit actuation when a detection confidence associated with fiducial detection is below a threshold. The engagement interlock may prevent actuation when fiducial markers are not detected.

According to another aspect of the present disclosure, a method for controlling docking of an unmanned aerial vehicle is provided. The method includes detecting a touchdown event indicating that the unmanned aerial vehicle has landed on a docking station. The method includes, after detecting the touchdown event, capturing image data of a fiducial marker array disposed on the docking station. The method includes detecting one or more fiducial markers in the image data. The method includes determining a pose of the unmanned aerial vehicle relative to the docking station based on the detected fiducial markers. The method includes permitting engagement of a docking mechanism only after determining that the pose satisfies an acceptance condition.

According to other aspects of the present disclosure, the method may include one or more of the following features. Capturing the image data may occur only after the touchdown event is detected. The method may further comprise preventing engagement of the docking mechanism when the fiducial markers are not detected after the touchdown event. Determining the pose may comprise computing a transform between a camera coordinate frame and a docking station coordinate frame. The method may further comprise capturing a plurality of image frames after the touchdown event and detecting fiducial markers across the plurality of image frames. Permitting engagement may comprise transitioning to an engagement state in a docking state machine.

According to another aspect of the present disclosure, a system for controlling docking of an unmanned aerial vehicle is provided. The system includes a docking station including an alignment mechanism having one or more contact surfaces. The system includes a processor configured to determine a pose of the unmanned aerial vehicle relative to the docking station, determine whether at least a portion of the unmanned aerial vehicle is positioned within an engagement region corresponding to the one or more contact surfaces, and permit engagement of the alignment mechanism only when the unmanned aerial vehicle is positioned within the engagement region.

According to other aspects of the present disclosure, the system may include one or more of the following features. The engagement region may correspond to a region in which the one or more contact surfaces are configured to contact landing legs of the unmanned aerial vehicle. The engagement region may comprise a plurality of subregions corresponding to respective landing interfaces of the unmanned aerial vehicle. Determining whether the unmanned aerial vehicle is within the engagement region may comprise evaluating at least one of a lateral offset or a rotational offset. Engagement may be inhibited when any portion of the unmanned aerial vehicle lies outside the engagement region. The engagement region may be defined based on geometric constraints of the alignment mechanism. The engagement region may include a tolerance region adjacent to a contact surface, wherein the tolerance region corresponds to positions that are within a permissible margin of error relative to the contact surfaces and in which actuation of the alignment mechanism is still expected to result in proper engagement without inducing displacement beyond a defined threshold. The landing interfaces may include landing legs, skids, or other structural portions of the unmanned aerial vehicle configured to contact the docking station.

In some aspects, preventing engagement of the docking mechanism includes refraining from actuating the docking mechanism. The system may withhold actuation commands, suppress actuation signals, or otherwise maintain the docking mechanism in a non-actuated state when alignment conditions are not satisfied or when fiducial markers are not detected.

According to another aspect of the present disclosure, a method for verifying a landing condition of an unmanned aerial vehicle is provided. The method includes capturing a plurality of image frames of a fiducial marker array after landing. The method includes detecting fiducial markers in one or more of the plurality of image frames. The method includes determining a pose of the unmanned aerial vehicle based on the detected fiducial markers. The method includes computing a confidence metric associated with the pose. The method includes permitting engagement of a docking mechanism only when the confidence metric exceeds a threshold.

According to other aspects of the present disclosure, the method may include one or more of the following features. Detecting fiducial markers may comprise detecting fiducial markers in at least a minimum number of frames. The confidence metric may be based on a number of detected fiducial markers. The confidence metric may be based on a size of detected fiducial markers in the image frames. The confidence metric may be based on consistency of pose estimates across frames. The method may further comprise inhibiting engagement when the confidence metric does not exceed the threshold. Capturing the plurality of image frames may occur within a predefined time window after landing.

According to another aspect of the present disclosure, a method for evaluating a landing condition of an unmanned aerial vehicle is provided. The method includes capturing image data of a fiducial marker array at a plurality of times after landing. The method includes determining a first pose of the unmanned aerial vehicle at a first time and a second pose at a second time. The method includes determining a change in pose between the first pose and the second pose. The method includes determining whether the landing condition is acceptable based on the change in pose.

According to other aspects of the present disclosure, the method may include one or more of the following features. The change in pose may correspond to a sliding motion of the unmanned aerial vehicle on a landing platform. The method may further comprise inhibiting engagement of a docking mechanism when the change in pose exceeds a threshold. The method may further comprise recording the change in pose as landing performance data. The method may further comprise adjusting a future landing trajectory based on the change in pose. Determining the change in pose may comprise computing a displacement vector. The plurality of times may comprise consecutive image frames after landing.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system architecture diagram of a drone docking system, according to aspects of the present disclosure.

FIG. 2A illustrates an isometric view of a drone docking system with an unmanned aerial vehicle in a separated position above a docking station, according to aspects of the present disclosure.

FIG. 2B illustrates an isometric view of the drone docking system of FIG. 2A with the unmanned aerial vehicle in a landed configuration, according to aspects of the present disclosure.

FIG. 3 illustrates a top view of a drone docking system with an unmanned aerial vehicle positioned on a landing platform, according to aspects of the present disclosure.

FIG. 4 illustrates a top view of a landing platform showing a fiducial marker array and alignment mechanism components, according to aspects of the present disclosure.

FIG. 5 illustrates an isometric view of an unmanned aircraft positioned on a docking station in a landed configuration, according to aspects of the present disclosure.

FIG. 6 illustrates a flowchart of a method for post-landing verification and docking engagement, according to aspects of the present disclosure.

FIG. 7 illustrates a state diagram for post-landing verification, safety gating, and automated recovery, according to aspects of the present disclosure.

FIG. 8 illustrates an example architecture of an unmanned aerial vehicle configured to perform post-landing visual verification for docking, according to aspects of the present disclosure.

FIG. 9 illustrates an example architecture of a docking station configured to support fiducial-based post-landing verification and controlled docking engagement, according to aspects of the present disclosure.

FIG. 10 illustrates a flowchart of a method for post-landing verification and docking engagement, according to aspects of the present disclosure.

FIG. 11 illustrates a flowchart of a method for controlled docking after touchdown detection, according to aspects of the present disclosure.

FIG. 12 illustrates a flowchart of a method for confidence-based landing verification, according to aspects of the present disclosure.

FIG. 13 illustrates a flowchart of a method for pose-change evaluation of a landing condition, according to aspects of the present disclosure.

FIG. 14 illustrates a flowchart of a method for docking an unmanned aerial vehicle at a docking station, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure describes systems and methods for fiducial-based post-landing verification in drone docking applications. In some aspects, a docking system may address challenges associated with verifying the position and orientation of an unmanned aerial vehicle (UAV) relative to a docking station after landing. The systems and methods described herein may provide post-landing visual confirmation to determine whether a UAV is positioned within acceptable alignment parameters before a docking mechanism is engaged.

In some cases, a docking station may include a fiducial marker array disposed on a landing platform. The fiducial marker array may comprise a plurality of fiducial markers of varying sizes. The varying sizes of the fiducial markers may ensure that at least one fiducial marker is detectable by a navigation camera under different conditions, including varying distances, view angles, and environmental factors. The fiducial markers may be strategically placed on the docking station to align with a field of view of the navigation camera mounted on the UAV.

In some aspects, a navigation camera mounted on the UAV may capture image data of the fiducial marker array after the UAV has landed on the landing platform. A post-landing visual confirmation system may detect one or more fiducial markers of the fiducial marker array in the captured image data. The post-landing visual confirmation system may determine a pose of the UAV relative to the docking station based on the detected fiducial markers. The pose may include a position and orientation of the UAV with respect to the docking station. The pose of the UAV may be expressed in terms of one or more alignment metrics, including lateral offset, rotational offset, or angular deviation relative to the docking station.

In some cases, the post-landing visual confirmation system may determine whether the pose satisfies one or more alignment conditions. The alignment conditions may define criteria used to determine whether actuation of the docking mechanism is permitted. In some aspects, alignment of the UAV relative to the docking station may be evaluated based on alignment conditions derived from the determined pose. The alignment conditions may include one or more criteria based on alignment parameters, such as whether the alignment parameters are acceptable. Alignment parameters may include lateral offset, rotational offset, yaw offset, or other alignment metrics and may be considered “acceptable” when these metrics are within corresponding thresholds. In some aspects, the acceptable alignment parameters may include predefined thresholds and, in some aspects, may be dynamically determined based on operating conditions, vehicle configuration, or other environmental factors. The alignment condition may further include geometric conditions such as whether the UAV is positioned within an engagement region associated with the docking mechanism. In some aspects, the engagement region corresponds to positions suitable for mechanical engagement of the UAV. When the pose satisfies alignment conditions, the post-landing visual confirmation system may generate an engagement authorization signal to permit engagement of a docking mechanism. The docking mechanism may be configured to secure, align, charge, or otherwise interface with the UAV after landing. The UAV may include landing interfaces, such as landing legs, skids, or other structural portions configured to contact the docking station.

In some aspects, the post-landing visual confirmation system may generate an engagement inhibit signal to prevent engagement of the docking mechanism when the pose does not satisfy alignment conditions. The post-landing visual confirmation system may also generate an engagement inhibit signal when fiducial markers are not detected in the image data. By gating engagement of the docking mechanism based on the determined pose, the systems and methods described herein may reduce the likelihood of actuating the docking mechanism when the UAV is not properly aligned with the docking station.

The systems and methods described herein may provide various technical effects and advantages in drone docking applications. In some aspects, the use of a multi-size fiducial marker array may enhance visibility and detection reliability during post-landing verification. The fiducial markers of varying sizes may ensure that at least one fiducial marker is detectable by a navigation camera under different conditions, including varying distances, view angles, and environmental factors. By deploying fiducial markers of multiple sizes across a landing platform, the systems and methods may increase the probability that at least one adequately resolved marker is within the field of view of the navigation camera, even when some markers are obscured or otherwise undetectable.

In some cases, the systems and methods may improve operational safety by preventing engagement of a docking mechanism when alignment is not within acceptable parameters. By gating engagement of the docking mechanism based on a post-landing determination of the pose of a UAV relative to a docking station, the systems and methods may ensure that the UAV is secured only when alignment is verified to be within acceptable limits. The post-landing visual confirmation system may generate an engagement inhibit signal to prevent actuation of the docking mechanism when fiducial markers are not detected or when the determined pose indicates that the UAV is not properly positioned for engagement.

In some aspects, the systems and methods may reduce the risk of damage during docking procedures. A UAV may touch down in a pose that is stable enough to remain on a landing platform but may not be suitable for mechanical engagement. Actuating an alignment mechanism or other docking mechanism when a UAV is not properly aligned may push the UAV out of position or create conditions that require manual intervention. By verifying the post-landing pose before permitting engagement, the systems and methods may mitigate risks associated with improper docking and reduce the likelihood of damage to the UAV or the docking station. In some cases, actuation of the docking mechanism when the UAV is not properly aligned may itself induce displacement or instability of the UAV. Such actuator-induced displacement may move the UAV further away from a desired alignment position or cause loss of stable contact with the landing platform.

In some cases, the systems and methods may provide adaptability to various environmental conditions. Environmental factors such as snow, water, lighting variations, and occlusions may affect the ability of a navigation camera to detect fiducial markers on a docking station. The use of fiducial markers of varying sizes may enhance detection robustness under such conditions. In some aspects, heating elements integrated into a docking station may melt snow or evaporate water from a landing platform to improve visibility of the fiducial marker array. These environmental adaptations may support reliable operation of the post-landing visual confirmation system across different weather conditions and lighting scenarios.

In some aspects, the systems and methods may provide scalability for different UAV models and docking station designs. Different UAVs may have different sizes, landing gear configurations, and camera placements, which may affect how the UAV interacts with a docking station. The fiducial marker array may be strategically placed on the docking station to align with the field of view of a navigation camera mounted on the UAV. The systems and methods may accommodate various configurations by adjusting the placement, size, and number of fiducial markers in the fiducial marker array to support detection across different UAV and docking station combinations.

In some cases, the systems and methods may support automated retry workflows to minimize human intervention requirements. When a post-landing visual confirmation system determines that a UAV is not within acceptable alignment parameters, the system may initiate a retry landing attempt by commanding the UAV to take off from the landing platform and attempt landing again. The system may also transmit an alert message to a remote operator interface when a bad landing is detected, enabling an operator to monitor the situation and provide commands if needed. By supporting automated retry workflows and operator notification, the systems and methods may reduce downtime due to docking-related issues and minimize the need for manual intervention at the docking station.

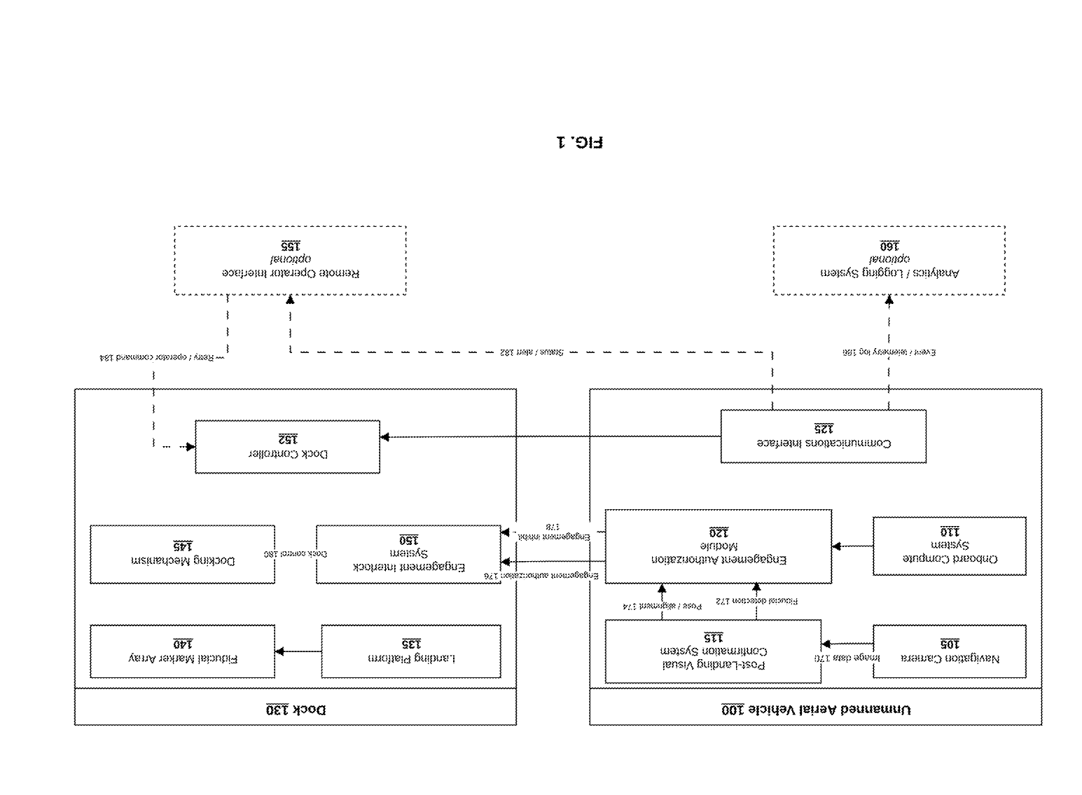

FIG. 1 illustrates a system architecture diagram of a drone docking system according to aspects of the present disclosure. The drone docking system may include a UAV 100 and a docking station 130 configured to receive UAV 100 after landing. The drone docking system may further include a remote operator interface 155 and an analytics / logging system 160 configured to support monitoring and data collection associated with docking operations.

UAV 100 may include a navigation camera 105 mounted on UAV 100. Navigation camera 105 may be configured to capture image data 170 of a fiducial marker array disposed on docking station 130. In some aspects, navigation camera 105 may be oriented to provide a field of view that includes a landing platform of docking station 130 during approach and after landing. Image data 170 captured by navigation camera 105 may include one or more image frames of the fiducial marker array.

UAV 100 may include an onboard compute system 110 configured to process data and execute control logic associated with docking operations. Onboard compute system 110 may include one or more processors and memory configured to execute software instructions. In some cases, onboard compute system 110 may be coupled to navigation camera 105 and may receive image data 170 for processing.

UAV 100 may include a post-landing visual confirmation system 115 that acts as a post-landing visual confirmation system configured to verify alignment of the UAV relative to the docking station 130 based on image data and control actuation of a docking mechanism. The post-landing visual confirmation system 115 is configured to process image data 170 captured by navigation camera 105 after UAV 100 has landed on docking station 130. The post-landing visual confirmation system 115 may detect one or more fiducial markers in image data 170 and may generate fiducial detection data 172 based on the detected fiducial markers. Fiducial detection data 172 may include information such as detected marker identifiers, corner coordinates, and detection quality metrics.

The post-landing visual confirmation system 115 may determine a pose of UAV 100 relative to docking station 130 based on fiducial detection data 172. The post-landing visual confirmation system 115 may generate a pose / alignment determination signal 174 that indicates the determined pose and whether the pose is within acceptable alignment parameters. Pose / alignment determination signal 174 may be provided to an engagement authorization module 120 of UAV 100.

Engagement authorization module 120 may be configured to evaluate pose / alignment determination signal 174 and determine whether to permit or inhibit engagement of a docking mechanism of docking station 130. Engagement authorization module 120 may generate an engagement authorization signal 176 to permit engagement of the docking mechanism when the pose is within acceptable alignment parameters. Engagement authorization module 120 may generate an engagement inhibit signal 178 to prevent engagement of the docking mechanism when the pose is not within acceptable alignment parameters or when fiducial markers are not detected in image data 170. In some aspects, the engagement authorization signal and the engagement inhibit signal collectively control whether the docking mechanism 145 is actuated. Actuation of the docking mechanism 145 may be performed when an authorization signal is generated, and actuation may be withheld or prevented when an inhibit signal is generated or when an authorization signal is not present. In some aspects, pose determination and actuation control are decoupled such that pose estimation is performed independently of docking mechanism control, and actuation of the docking mechanism is gated based on outputs of the pose determination. Actuation of the docking mechanism may include initiating mechanical movement or operation of one or more components of the docking mechanism to engage the UAV.

UAV 100 may include a communications interface 125 configured to communicate with docking station 130 and external systems. Communications interface 125 may transmit engagement authorization signal 176 or engagement inhibit signal 178 to docking station 130. Communications interface 125 may also transmit a status / alert signal 182 to remote operator interface 155 when a landing is determined to be unacceptable. Communications interface 125 may receive a retry / command signal 184 from remote operator interface 155 in response to an alert. Communications interface 125 may transmit an event / telemetry log signal 186 to analytics / logging system 160 for recording pose-related data and event information associated with docking operations.

Docking station 130 may include a landing platform 135 configured to receive UAV 100 after landing. Landing platform 135 may provide a surface area on which UAV 100 touches down during docking operations. Docking station 130 may include a fiducial marker array 140 disposed on landing platform 135. Fiducial marker array 140 may comprise a plurality of fiducial markers configured for detection by navigation camera 105. In some aspects, fiducial marker array 140 may include fiducial markers of varying sizes to ensure that at least one fiducial marker is detectable under different conditions.

Docking station 130 may include a docking mechanism 145 configured to engage UAV 100 when UAV 100 is positioned on landing platform 135. Docking mechanism 145 may be configured to secure, align, charge, or otherwise interface with UAV 100 after landing. In some cases, docking mechanism 145 may include an alignment mechanism having one or more contact surfaces configured to center and secure UAV 100 on landing platform 135 upon actuation of the docking mechanism.

Docking station 130 may include an engagement interlock system 150 configured to control actuation of docking mechanism 145 based on engagement authorization signal 176 or engagement inhibit signal 178. Engagement interlock system 150 may be configured to receive engagement authorization signal 176 and permit actuation of docking mechanism 145 upon receipt of engagement authorization signal 176. Engagement interlock system 150 may be configured to prevent actuation of docking mechanism 145 in the absence of engagement authorization signal 176 or upon receipt of engagement inhibit signal 178.

In some aspects, engagement interlock system 150 may be implemented in different configurations. Engagement interlock system 150 may be implemented purely in aircraft software by suppressing an engage command such that the engage command is not transmitted to docking station 130. Engagement interlock system 150 may be implemented in dock control logic where docking station 130 refuses actuation of docking mechanism 145 absent authorization. Engagement interlock system 150 may be implemented as a hardware safety interlock that prevents mechanical actuation of docking mechanism 145. In some cases, engagement interlock system 150 may include a combination of software and hardware interlock mechanisms.

Docking station 130 may include a dock controller 152 configured to control operation of docking mechanism 145 and other components of docking station 130. Dock controller 152 may receive a dock control signal 180 from engagement interlock system 150. Dock control signal 180 may indicate whether actuation of docking mechanism 145 is permitted based on the state of engagement interlock system 150. Dock controller 152 may coordinate operation of landing platform 135, fiducial marker array 140, and docking mechanism 145 based on dock control signal 180.

Remote operator interface 155 may be configured to receive status / alert signal 182 from communications interface 125 of UAV 100. Remote operator interface 155 may display alerts and status information to an operator when a landing is determined to be unacceptable. Remote operator interface 155 may enable an operator to provide retry / command signal 184 to communications interface 125, allowing the operator to command a retry landing attempt or provide other instructions.

Analytics / logging system 160 may be configured to receive event / telemetry log signal 186 from communications interface 125. Analytics / logging system 160 may store pose-related data, detection metrics, and event information associated with docking operations. In some aspects, analytics / logging system 160 may record landing performance data that may be used for fleet tuning or adjustment of future landing trajectories.

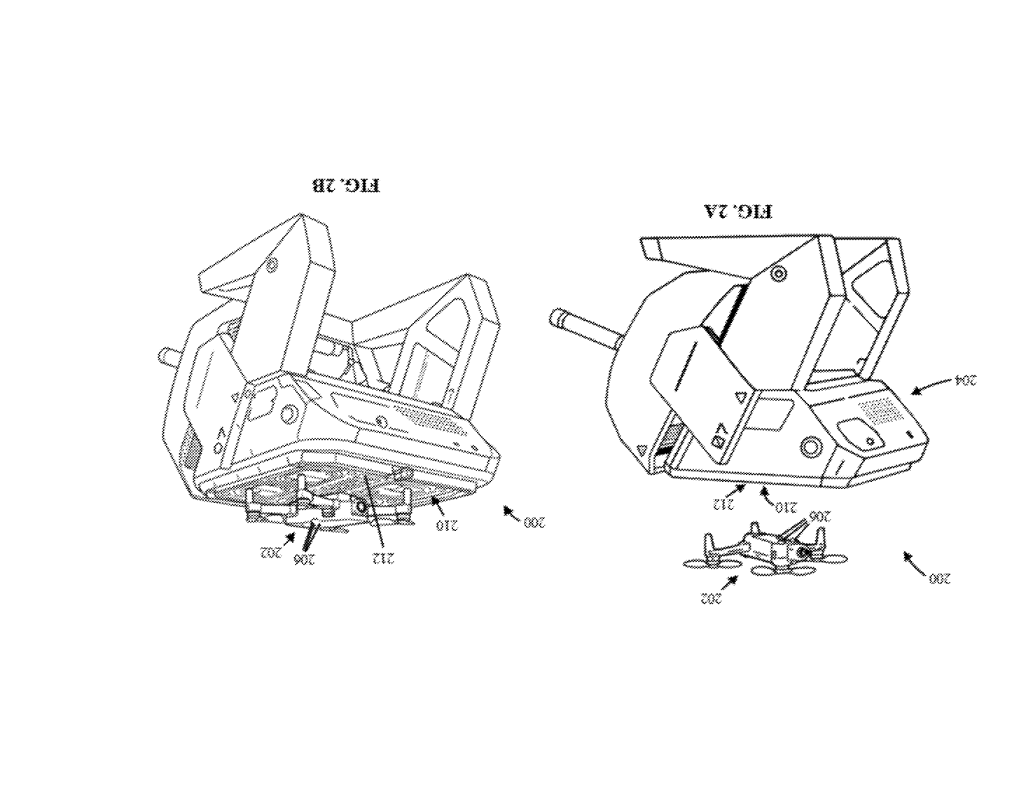

FIGS. 2A-2B illustrate isometric views of a drone docking system 200 according to aspects of the present disclosure. FIG. 2A illustrates drone docking system 200 with a UAV 202 shown in a separated position above a docking station 204. FIG. 2B illustrates drone docking system 200 with UAV 202 positioned on a landing platform 210 of docking station 204 in a landed configuration.

Referring to FIG. 2A, UAV 202 may be depicted as a quadcopter-style UAV with four rotors. UAV 202 may include a navigation camera 206 mounted on an underside of UAV 202. Navigation camera 206 may be oriented to provide a field of view that includes landing platform 210 of docking station 204 during approach and after landing. In some aspects, navigation camera 206 may be an infrared camera capable of detecting fiducial markers under low-light or nighttime conditions. In some cases, navigation camera 206 may be a stereoscopic camera providing depth information for enhanced pose estimation.

Docking station 204 may include a housing structure with an angular, faceted exterior design and multiple leg supports that elevate docking station 204 above a ground surface. Landing platform 210 may be positioned on an upper surface of docking station 204 and may provide a designated area for UAV 202 to land upon. A fiducial marker array 212 may be disposed on landing platform 210. Fiducial marker array 212 may include a plurality of fiducial markers that are visible to navigation camera 206 during approach and after landing. The fiducial markers of fiducial marker array 212 may be strategically placed to align with the field of view of navigation camera 206, enabling detection under varying conditions.

In some aspects, fiducial marker array 212 may include fiducial markers of varying sizes. The varying sizes of the fiducial markers may ensure that at least one fiducial marker is detectable by navigation camera 206 under different conditions, including varying distances, view angles, and environmental factors. By deploying fiducial markers of multiple sizes across landing platform 210, drone docking system 200 may increase the probability that at least one adequately resolved marker is within the field of view of navigation camera 206, even when some markers are obscured or otherwise undetectable.

In some cases, the fiducial markers of fiducial marker array 212 may be printed on stock material and adhered to a surface of landing platform 210. In some aspects, the fiducial markers may be integrated directly into dock top materials during manufacturing. Fiducial marker array 212 may include optional protective layers over the fiducial markers to protect the fiducial markers from environmental conditions or wear.

Referring to FIG. 2B, UAV 202 may be positioned on landing platform 210 of docking station 204 in a landed configuration. In the landed configuration, navigation camera 206 of UAV 202 may be oriented toward fiducial marker array 212 on landing platform 210. Navigation camera 206 may capture image data of fiducial marker array 212 after UAV 202 has landed on landing platform 210. The image data captured by navigation camera 206 may enable post-landing visual confirmation of a position and orientation of UAV 202 relative to docking station 204.

The arrangement of drone docking system 200 may enable verification of alignment between UAV 202 and docking station 204 prior to engagement of a docking mechanism. A post-landing visual confirmation system may detect one or more fiducial markers of fiducial marker array 212 in the image data captured by navigation camera 206 and may determine a pose of UAV 202 relative to docking station 204 based on the detected fiducial markers. The post-landing visual confirmation system may determine whether the pose satisfies an alignment condition (e.g., pose is within acceptable alignment parameters) and may generate an engagement authorization signal to permit engagement of the docking mechanism when the pose is within the acceptable alignment parameters.

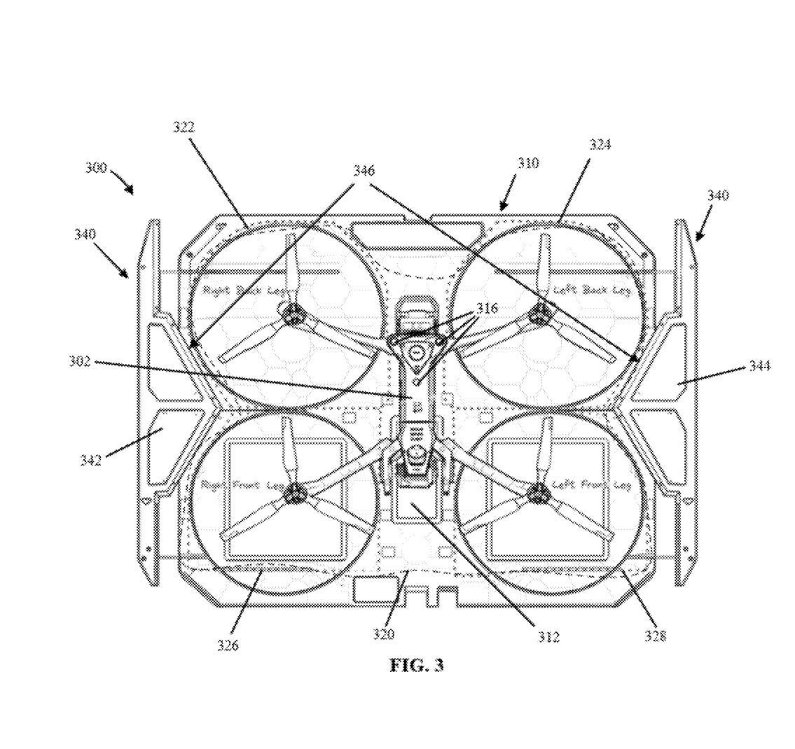

FIG. 3 illustrates a top view of a drone docking system 300 with a UAV 302 positioned on a landing platform 310 in a landed configuration according to aspects of the present disclosure. UAV 302 may be depicted as a quadcopter-style UAV with four rotors enclosed within protective shrouds. In some embodiments, the UAV 302 is similar to the UAV 100 of FIG. 1. A navigation camera 316 may be mounted on a central body of UAV 302 and may be oriented downward toward landing platform 310, enabling imaging of a fiducial marker array 312 disposed on the landing surface.

Landing platform 310 may include fiducial marker array 312 positioned in a central region of the platform surface. Fiducial marker array 312 may comprise a plurality of fiducial markers that are visible to navigation camera 316 for post-landing visual confirmation of the position and orientation of UAV 302 relative to the docking station.

The top view may illustrate an acceptable landing region 320 indicated by dashed outlines that define boundaries within which legs of UAV 302 should be positioned for safe engagement of a docking mechanism. Acceptable landing region 320 may be subdivided into a first landing region 322, a second landing region 324, a third landing region 326, and a fourth landing region 328, each corresponding to a respective leg position of UAV 302. In some aspects, first landing region 322 may correspond to a right back leg position, second landing region 324 may correspond to a left back leg position, third landing region 326 may correspond to a right front leg position, and fourth landing region 328 may correspond to a left front leg position. The dashed outlines may indicate that all four legs of UAV 302 should be within their respective landing regions for the alignment to be within acceptable parameters.

An alignment mechanism 340 may be disposed on landing platform 310 and may include a first alignment member 342 and a second alignment member 344 positioned on opposite sides of the landing surface. First alignment member 342 and second alignment member 344 may each include alignment projections / contact surfaces 346 that extend toward a center of landing platform 310. Alignment projections / contact surfaces 346 may be configured to engage with UAV 302 when the alignment mechanism is actuated, securing the aircraft to the docking station.

The arrangement of alignment mechanism 340 with first alignment member 342 and second alignment member 344 may enable centering and securing of UAV 302 when a post-landing visual confirmation system determines that alignment is within acceptable parameters based on detection of fiducial marker array 312 by navigation camera 316. In some cases, the post-landing visual confirmation system may verify that each leg of UAV 302 is positioned within its corresponding landing region before generating an engagement authorization signal to permit actuation of alignment mechanism 340.

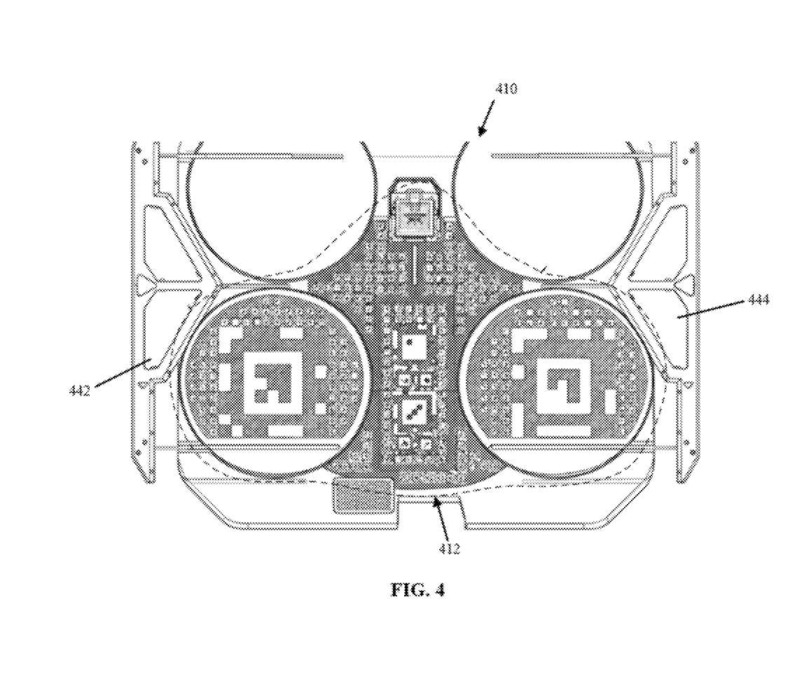

FIG. 4 illustrates a top view of a landing platform 410 showing an arrangement of a fiducial marker array 412 and alignment mechanism components according to aspects of the present disclosure. Landing platform 410 may provide a surface area on which a UAV touches down during docking operations.

Fiducial marker array 412 may be disposed on landing platform 410 and may comprise a plurality of fiducial markers of varying sizes strategically placed across the platform surface. In some aspects, fiducial marker array 412 may comprise AprilTags as a fiducial marker implementation. In some cases, fiducial marker array 412 may comprise ArUco markers as an alternative fiducial marker implementation. The fiducial markers may be machine-detectable planar visual tags configured for identification and pose estimation.

The fiducial markers of fiducial marker array 412 may be arranged in a pattern that includes larger markers positioned in circular regions on left and right sides of landing platform 410, and smaller markers distributed in a central region between the circular areas. In some aspects, large tags may be placed near a perimeter of landing platform 410 and smaller tags may be placed near a center of landing platform 410. The varying sizes of the fiducial markers within fiducial marker array 412 may ensure that at least one marker is detectable by a navigation camera under different conditions, including varying distances, view angles, and environmental factors. By deploying fiducial markers of multiple sizes across landing platform 410, the arrangement may increase the probability that at least one adequately resolved marker is within a field of view of the navigation camera, even when some markers are obscured or otherwise undetectable.

In some cases, a post-landing visual confirmation system may require a minimum pixel size for detected fiducial markers to ensure reliable pose estimation. The larger markers positioned near the perimeter of landing platform 410 may provide sufficient pixel resolution when the navigation camera is at greater distances or oblique view angles. The smaller markers distributed in the central region may provide detection capability when the navigation camera is positioned closer to landing platform 410 after touchdown.

In some aspects, the post-landing visual confirmation system may require a minimum number of detected tags or a minimum number of frames containing detected tags before authorizing engagement of a docking mechanism. The distribution of fiducial markers across fiducial marker array 412 may support detection of multiple markers across different camera positions and orientations, thereby supporting confidence-based verification of a landing condition.

The fiducial markers of fiducial marker array 412 may include patterns configured for machine detection and pose estimation, enabling calculation of a position and orientation of a UAV relative to a docking station after landing. The arrangement of fiducial markers across landing platform 410 may be designed so that at least one tag is likely in view for an expected touchdown distribution of the UAV.

A first alignment member 442 may be positioned on a left side of landing platform 410 and a second alignment member 444 may be positioned on a right side of landing platform 410. First alignment member 442 and second alignment member 444 may be disposed on opposite sides of the landing surface and may form part of an alignment mechanism configured to engage with a UAV when actuated. First alignment member 442 and second alignment member 444 may include contact surfaces that extend toward a center of landing platform 410 for centering and securing a UAV when a post-landing visual confirmation system determines that alignment is within acceptable parameters based on detection of fiducial marker array 412.

The arrangement of fiducial marker array 412 on landing platform 410 with first alignment member 442 and second alignment member 444 may enable verification of alignment between a UAV and a docking station prior to engagement of the alignment mechanism. The post-landing visual confirmation system may detect one or more fiducial markers of fiducial marker array 412 in image data captured by a navigation camera and may determine a pose of the UAV relative to the docking station based on the detected fiducial markers. When the pose is within acceptable alignment parameters, the post-landing visual confirmation system may generate an engagement authorization signal to permit actuation of the alignment mechanism including first alignment member 442 and second alignment member 444.

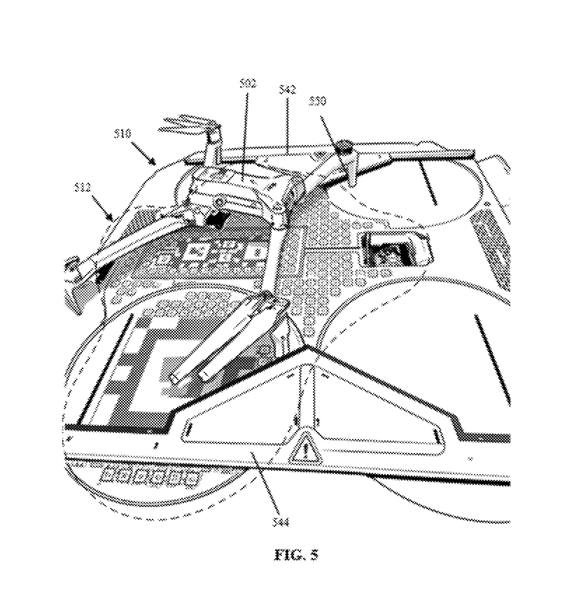

FIG. 5 illustrates an isometric view of a drone docking system with an unmanned aircraft 502 positioned on a docking station 550 in a landed configuration according to aspects of the present disclosure. Unmanned aircraft 502 may be depicted as a quadcopter-style vehicle with four rotor arms 510 extending outward from a central body. Each rotor arm 510 may support a rotor 512 at a distal end of rotor arm 510. Rotors 512 may be enclosed within protective shrouds that surround rotor blades of rotors 512. The protective shrouds may provide protection for rotors 512 during flight operations and docking procedures.

Docking station 550 may include a landing platform surface on which unmanned aircraft 502 has touched down. The landing platform may feature a fiducial marker array 542 disposed across the platform surface. Fiducial marker array 542 may comprise a plurality of fiducial markers of varying sizes arranged in a pattern across the landing surface. In some aspects, fiducial marker array 542 may include larger markers positioned in circular regions and smaller markers distributed across the landing surface. The varying sizes of the fiducial markers within fiducial marker array 542 may ensure that at least one marker is detectable by a navigation camera mounted on unmanned aircraft 502 under different conditions, including varying distances, view angles, and environmental factors. The fiducial markers may include patterns configured for machine detection and pose estimation, enabling calculation of a position and orientation of unmanned aircraft 502 relative to docking station 550 after landing.

A warning indicator 544 may be positioned on the landing platform surface of docking station 550. Warning indicator 544 may include a triangular shape with an exclamation mark symbol. Warning indicator 544 may provide a visual indication related to docking operations or safety status.

The arrangement of unmanned aircraft 502 on docking station 550 with fiducial marker array 542 may enable post-landing visual confirmation of the position and orientation of unmanned aircraft 502 relative to docking station 550. The fiducial markers of fiducial marker array 542 may be strategically placed to align with a field of view of a navigation camera on unmanned aircraft 502, supporting verification of alignment between unmanned aircraft 502 and docking station 550 prior to engagement of a docking mechanism.

In some aspects, docking station 550 may include heating elements integrated into the landing platform. The heating elements may melt snow on fiducial marker array 542 to improve marker visibility. In some cases, the heating elements may evaporate water on fiducial marker array 542 to improve marker visibility. The heating elements may activate when snow or water is detected on the landing platform surface, thereby enhancing detection capabilities of the navigation camera under various environmental conditions. The heating elements may ensure that fiducial marker array 542 remains detectable, facilitating accurate calculation of the position and orientation of unmanned aircraft 502 relative to docking station 550.

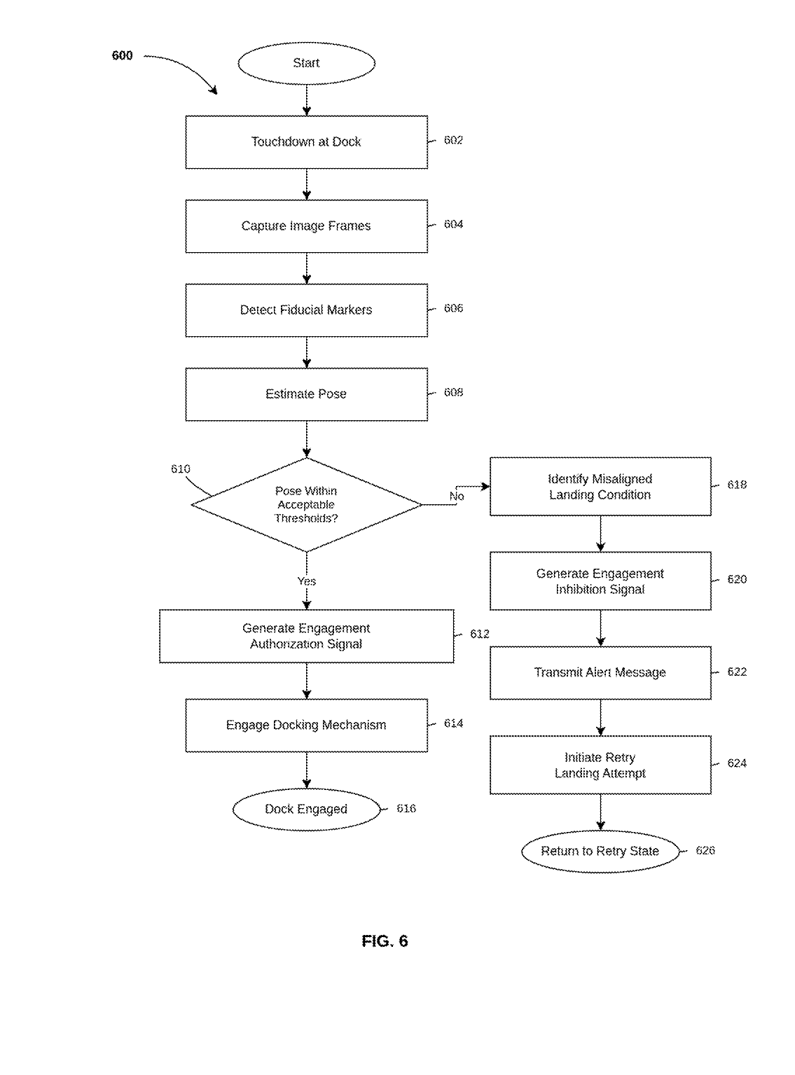

FIG. 6 illustrates a flowchart of a method 600 for post-landing verification and docking engagement according to aspects of the present disclosure. Method 600 may be performed by a post-landing visual confirmation system of a UAV after the UAV has landed on a docking station.

Method 600 may begin at a step 602 where the UAV performs touchdown at a dock. At step 602, the UAV may land on a landing platform of the docking station. In some aspects, touchdown detection may be based on an inertial measurement unit (IMU) signature indicating contact with the landing platform. In some cases, touchdown detection may be based on motor state changes indicating the UAV has landed. In some aspects, touchdown detection may be based on a contact sensor disposed on the UAV or the landing platform. In some cases, touchdown detection may be vision-based using changes in a camera view to detect landing.

At a step 604, image frames may be captured by a navigation camera mounted on the UAV. The navigation camera may capture one or more image frames of a fiducial marker array disposed on the landing platform of the docking station. In some aspects, the navigation camera may capture a plurality of image frames after touchdown to support detection and pose estimation.

At a step 606, fiducial markers may be detected in the captured image frames. A post-landing visual confirmation system may process the image frames to detect one or more fiducial markers of the fiducial marker array. In some cases, the fiducial marker array may comprise fiducial markers of varying sizes, and the post-landing visual confirmation system may detect at least one fiducial marker of the fiducial markers of varying sizes.

At a step 608, a pose of the UAV relative to the docking station may be estimated. The post-landing visual confirmation system may compute a relative position and orientation of the UAV with respect to the docking station based on detected corners of the one or more fiducial markers. In some aspects, the pose estimation may include computing a transform between a camera coordinate frame and a docking station coordinate frame.

In some aspects, the engagement region may be defined in a coordinate frame of the docking station and evaluated by comparing the determined pose of the UAV to geometric constraints associated with the alignment mechanism.

At a step 610, a determination may be made whether the pose satisfies predefined thresholds corresponding to the acceptable alignment parameters. The post-landing visual confirmation system may compare at least one of a lateral offset, a rotational offset, or a yaw offset to a corresponding acceptance threshold. In some cases, the predefined thresholds may define alignment parameters within which engagement of a docking mechanism is permitted.

When the pose is within predefined thresholds at step 610, method 600 may proceed along an affirmative branch. At a step 612, an engagement authorization signal may be generated. The post-landing visual confirmation system may generate the engagement authorization signal to permit engagement of the docking mechanism when the pose is within the acceptable alignment parameters.

At a step 614, the docking mechanism may be engaged. The docking mechanism may be configured to secure, align, charge, or otherwise interface with the UAV after landing. In some aspects, the docking mechanism may include an alignment mechanism having one or more contact surfaces configured to center and secure the UAV on the landing platform.

At a step 616, method 600 may terminate with an indication that the dock is engaged. The UAV may be secured to the docking station and docking operations may proceed.

When the pose is not within predefined thresholds at step 610, method 600 may proceed along a negative branch. At a step 618, a misaligned landing condition may be identified. The post-landing visual confirmation system may determine that the UAV is not positioned within acceptable alignment parameters for engagement of the docking mechanism.

At a step 620, an engagement inhibition signal may be generated. The post-landing visual confirmation system may generate the engagement inhibition signal to prevent engagement of the docking mechanism when the pose is not within the acceptable alignment parameters. In some aspects, the post-landing visual confirmation system may also generate an engagement inhibit signal when fiducial markers are not detected in the image data.

At a step 622, an alert message may be transmitted. The post-landing visual confirmation system may transmit the alert message to a remote operator interface when the pose is not within the acceptable alignment parameters. In some cases, the alert message may notify an operator of the misaligned landing condition and may enable the operator to provide commands for corrective action. In some aspects, the post-landing visual confirmation system may alert an operator for manual intervention when fiducial markers are not detected or alignment is not within acceptable parameters.

At a step 624, a retry landing attempt may be initiated. The post-landing visual confirmation system may prompt a re-landing attempt when fiducial markers are not detected or alignment is not within acceptable parameters. In some aspects, the retry workflow may be automated where the UAV autonomously takes off from the landing platform and attempts landing again. In some cases, the retry workflow may be manual where an operator commands the UAV to retry landing via the remote operator interface.

At a step 626, method 600 may terminate with an indication of return to a retry state. The UAV may take off from the landing platform and attempt to land again on the docking station. In some aspects, the retry landing attempt may be repeated until the pose is within predefined thresholds or until a retry counter exceeds a threshold.

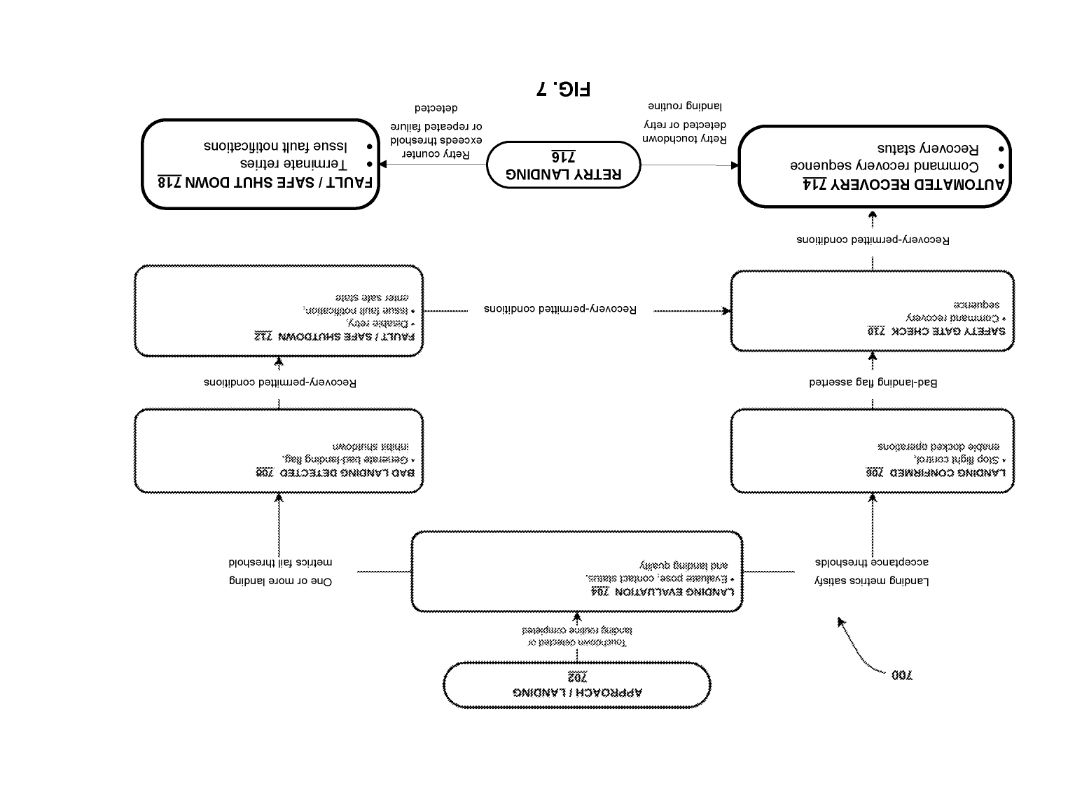

FIG. 7 illustrates a state diagram 700 for post-landing verification, safety gating, and automated recovery according to aspects of the present disclosure. State diagram 700 may depict states and transitions associated with verifying a landing condition of a UAV and controlling engagement of a docking mechanism based on the verified landing condition.

State diagram 700 may begin at an approach / landing state 702 where a UAV approaches and lands on a docking station. In approach / landing state 702, the UAV may execute a landing routine to touch down on a landing platform of the docking station. The UAV may descend toward the landing platform and contact the landing surface during approach / landing state 702.

Upon detection of a touchdown event or completion of a landing routine, state diagram 700 may transition from approach / landing state 702 to a landing evaluation state 704. Landing evaluation state 704 may evaluate pose, contact status, and landing quality of the UAV relative to the docking station. In landing evaluation state 704, a post-landing visual confirmation system may capture image data of a fiducial marker array disposed on the landing platform and may detect one or more fiducial markers in the captured image data. The post-landing visual confirmation system may determine a pose of the UAV relative to the docking station based on the detected fiducial markers.

In some aspects, the system may define a capture window after touchdown specifying timing for image capture and pose verification. The capture window may begin immediately after touchdown detection or after a settling period. The post-landing visual confirmation system may capture a plurality of image frames within the capture window to support detection and pose estimation.

In some cases, the system may define a maximum wait time before declaring the landing state as unsafe or unknown and inhibiting closure. When the maximum wait time elapses without successful pose verification, the system may transition to a state in which engagement of the docking mechanism is prevented.

When landing metrics satisfy acceptance thresholds in landing evaluation state 704, state diagram 700 may transition to a landing confirmed state 706. Landing confirmed state 706 may stop flight control and enable docked operations. In landing confirmed state 706, the post-landing visual confirmation system may generate an engagement authorization signal to permit engagement of the docking mechanism. The docking mechanism may be actuated to secure, align, charge, or otherwise interface with the UAV.

When one or more landing metrics fail threshold in landing evaluation state 704, state diagram 700 may transition to a bad landing detected state 708. Bad landing detected state 708 may generate a bad-landing flag and inhibit shutdown of the UAV. In bad landing detected state 708, the post-landing visual confirmation system may generate an engagement inhibit signal to prevent engagement of the docking mechanism. The system may maintain the UAV in a state where flight control remains available for recovery operations.

From landing confirmed state 706, a bad-landing flag asserted condition may trigger transition to a safety gate check state 710. Safety gate check state 710 may evaluate whether recovery operations are permitted based on current conditions. In some aspects, safety gate check state 710 may evaluate factors such as battery level, wind conditions, and communication link status before permitting recovery operations.

From bad landing detected state 708, recovery-permitted conditions may trigger transition to a fault / safe shutdown state 712. Fault / safe shutdown state 712 may disable retry, issue fault notification, and enter a safe state. In fault / safe shutdown state 712, the system may alert an operator for manual intervention and may prevent further automated recovery attempts.

Fault / safe shutdown state 712 may transition to safety gate check state 710 upon recovery-permitted conditions. Safety gate check state 710 may command a recovery sequence when conditions permit automated recovery.

Safety gate check state 710 may transition to an automated recovery state 714 upon recovery-permitted conditions. Automated recovery state 714 may command a recovery sequence and provide recovery status. In automated recovery state 714, the UAV may take off from the landing platform and prepare for a retry landing attempt.

A retry landing state 716 may transition to automated recovery state 714 upon retry touchdown detected or retry landing routine. Retry landing state 716 may represent a state in which the UAV attempts to land again on the docking station after a previous landing was determined to be unacceptable.

When a retry counter exceeds a threshold or repeated failure is detected, retry landing state 716 may transition to a fault / safe shutdown state 718. Fault / safe shutdown state 718 may terminate retries and issue fault notification. In fault / safe shutdown state 718, the system may prevent further automated retry attempts and may alert an operator for manual intervention.

In some aspects, a local interlock may inhibit engagement even when a remote operator interface cannot be reached due to loss of link. The local interlock may preserve safety by preventing actuation of the docking mechanism based on onboard decision logic and dock-local gating, independent of communication with external systems. The local interlock may ensure that engagement is inhibited when the landing condition is determined to be unsafe, regardless of whether the remote operator interface is reachable.

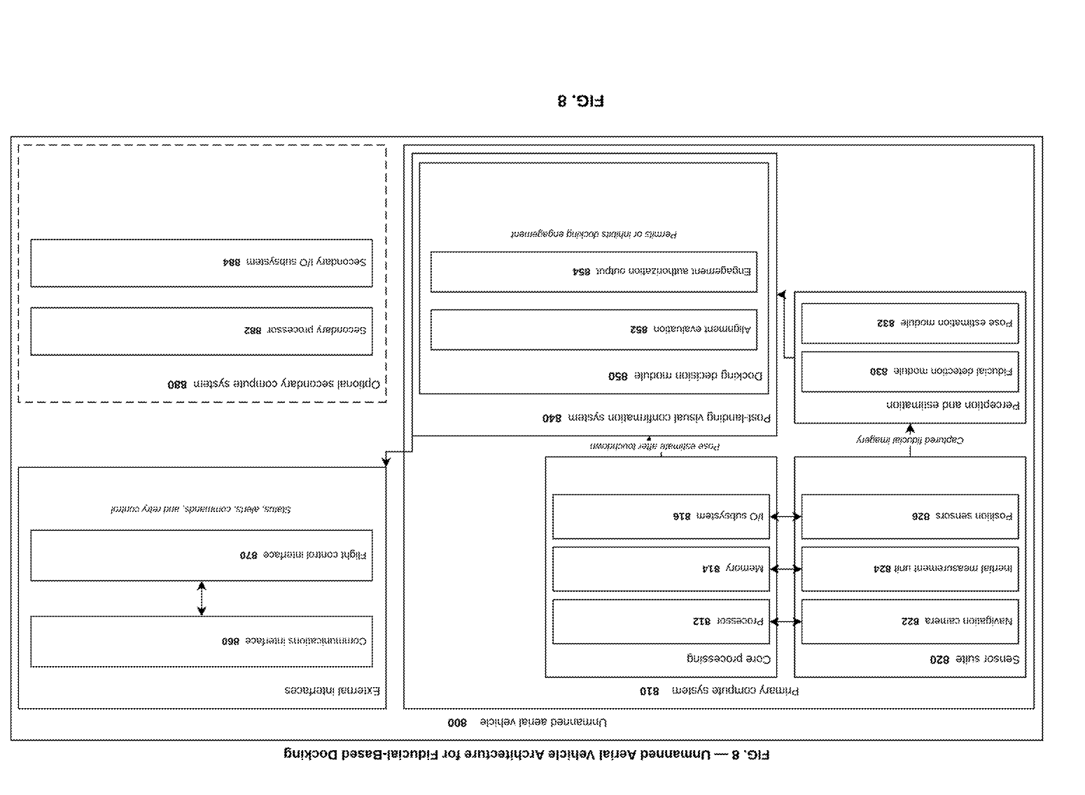

FIG. 8 illustrates an example architecture of a UAV 800 configured to perform post-landing visual verification for docking according to aspects of the present disclosure. In some embodiments, the UAV 800 is similar to the UAV 100 of FIG. 1. The UAV 800 may include components configured to capture image data of a fiducial marker array disposed on a docking station, detect fiducial markers in the captured image data, determine a pose of UAV 800 relative to the docking station, and generate control outputs based on the determined pose.

The UAV 800 may include a primary compute system 810 configured to process sensor data and execute control logic associated with docking operations. Primary compute system 810 may include a processor 812 configured to execute software instructions for fiducial detection, pose estimation, and docking decision logic. Primary compute system 810 may include a memory 814 configured to store software instructions, fiducial dictionaries, calibration parameters, and data associated with docking operations. Memory 814 may include non-volatile memory such as magnetic disk storage devices, solid-state drives, or flash memory. Memory 814 may include volatile memory such as RAM, DRAM, or SRAM for temporary storage of data during operation. Primary compute system 810 may include an I/O subsystem 816 configured to interface with sensors, communication modules, and other components of UAV 800.

UAV 800 may include a sensor suite 820 configured to capture data for navigation and docking operations. Sensor suite 820 may include a navigation camera 822 configured to capture images of a fiducial marker array disposed on a docking station. Navigation camera 822 may be oriented to provide a field of view that includes a landing platform of the docking station during approach and after landing. In some aspects, navigation camera 822 may be a downward-facing camera mounted on an underside of UAV 800. In some cases, navigation camera 822 may be an infrared camera capable of detecting fiducial markers under low-light or nighttime conditions.

In some aspects, UAV 800 may include multiple cameras for redundancy. When multiple cameras are available, the system may require agreement between cameras or may select a camera based on detection confidence. The selection of a camera based on detection confidence may support reliable pose estimation when one camera provides higher quality detections than another camera.

Sensor suite 820 may include an inertial measurement unit 824 configured to measure acceleration and angular velocity of UAV 800. Inertial measurement unit 824 may provide data for detecting a touchdown event indicating that UAV 800 has landed on the docking station. In some aspects, touchdown detection may be based on an IMU signature indicating contact with a landing platform. Sensor suite 820 may include position sensors 826 configured to provide position information for UAV 800. Position sensors 826 may include global navigation satellite system (GNSS) receivers or other position sensing devices.

In some cases, UAV 800 may operate in GNSS-denied environments. In GNSS-denied environments, UAV 800 may rely on fiducial-based pose estimation for docking operations. Docking pose estimation via fiducials may be GNSS-independent, relying on navigation camera 822 and known fiducial marker geometry to determine the pose of UAV 800 relative to the docking station.

UAV 800 may include a fiducial detection module 830 configured to detect fiducial markers in image data captured by navigation camera 822. Fiducial detection module 830 may receive image frames from navigation camera 822 and may process the image frames to identify fiducial markers within the captured images. Fiducial detection module 830 may output detected tag identifiers, corner coordinates, and per-detection confidence or quality metrics for each detected marker. The per-detection confidence or quality metrics may indicate a reliability of each detection and may be used for subsequent pose estimation and engagement decisions.

In some aspects, fiducial detection module 830 may apply multi-frame debouncing to improve detection confidence before making engagement decisions. Multi-frame debouncing may involve processing detections across multiple image frames and requiring consistent detections over a number of frames before confirming a detection result. Multi-frame debouncing may trade off latency against confidence, with safety considerations prioritizing confidence over speed. In some aspects, the system may determine that fiducial markers are not detected when detection fails across a plurality of image frames captured after touchdown, thereby reducing the likelihood of false negatives due to transient occlusions or noise.

UAV 800 may include a pose estimation module 832 configured to determine a relative position and orientation of UAV 800 with respect to the docking station based on detected fiducial markers. Pose estimation module 832 may receive detected tag identifiers and corner coordinates from fiducial detection module 830. Pose estimation module 832 may compute a six-degree-of-freedom (6-DOF) relative transform between a coordinate frame of navigation camera 822 and a coordinate frame of the fiducial markers or the docking station. The 6-DOF relative transform may include translational components along three axes and rotational components about three axes.

Pose estimation module 832 may use known fiducial marker geometry, camera calibration parameters, and fiducial marker layout in a dock coordinate frame to compute the relative transform. In some aspects, pose estimation module 832 may compute the pose from a single image frame when fiducial markers are detected with sufficient quality. In some cases, pose estimation module 832 may aggregate pose estimates across multiple frames to improve accuracy and consistency.

UAV 800 may include a post-landing visual confirmation system 840 configured to evaluate the determined pose after touchdown to verify whether UAV 800 is positioned within acceptable alignment parameters relative to the docking station. Post-landing visual confirmation system 840 may receive pose information from pose estimation module 832 and may compare the pose to acceptance thresholds. The acceptance thresholds may include lateral translation bounds, yaw bounds, roll bounds, pitch bounds, confidence thresholds, and minimum required numbers of detected fiducial markers.

UAV 800 may include a docking decision module 850 configured to generate a control output based on the evaluation performed by post-landing visual confirmation system 840. Docking decision module 850 may include an alignment evaluation 852 configured to evaluate whether the pose of UAV 800 satisfies acceptance conditions for engagement of a docking mechanism. Alignment evaluation 852 may compare lateral offsets, rotational offsets, and yaw offsets to corresponding acceptance thresholds.

Docking decision module 850 may include an engagement authorization output 854 configured to permit or inhibit engagement of a docking mechanism of the docking station depending on whether the alignment is determined to be acceptable. Engagement authorization output 854 may generate an engagement authorization signal when the pose is within acceptable alignment parameters. Engagement authorization output 854 may generate an engagement inhibit signal when the pose is not within acceptable alignment parameters or when fiducial markers are not detected in the image data.

UAV 800 may include a communications interface 860 configured to transmit status information, alerts, or commands to external systems. Communications interface 860 may transmit the engagement authorization signal or the engagement inhibit signal to the docking station. Communications interface 860 may transmit alert messages to a remote operator interface when a landing is determined to be unacceptable. Communications interface 860 may receive retry commands from the remote operator interface in response to an alert.

UAV 800 may include a flight control interface 870 configured to control flight operations of UAV 800. Flight control interface 870 may control repositioning maneuvers or retry maneuvers when a landing is determined to be unacceptable. In some aspects, flight control interface 870 may command UAV 800 to take off from the landing platform and attempt landing again when post-landing visual confirmation system 840 determines that the pose is not within acceptable alignment parameters.

UAV 800 may include a secondary compute system 880 configured to execute functions separate from the primary docking verification functions. Secondary compute system 880 may include a secondary processor 882 configured to execute software instructions. Secondary compute system 880 may include a secondary I/O subsystem 884 configured to interface with components of UAV 800. In some aspects, secondary compute system 880 may execute non-critical functions while primary compute system 810 executes docking-related processing.

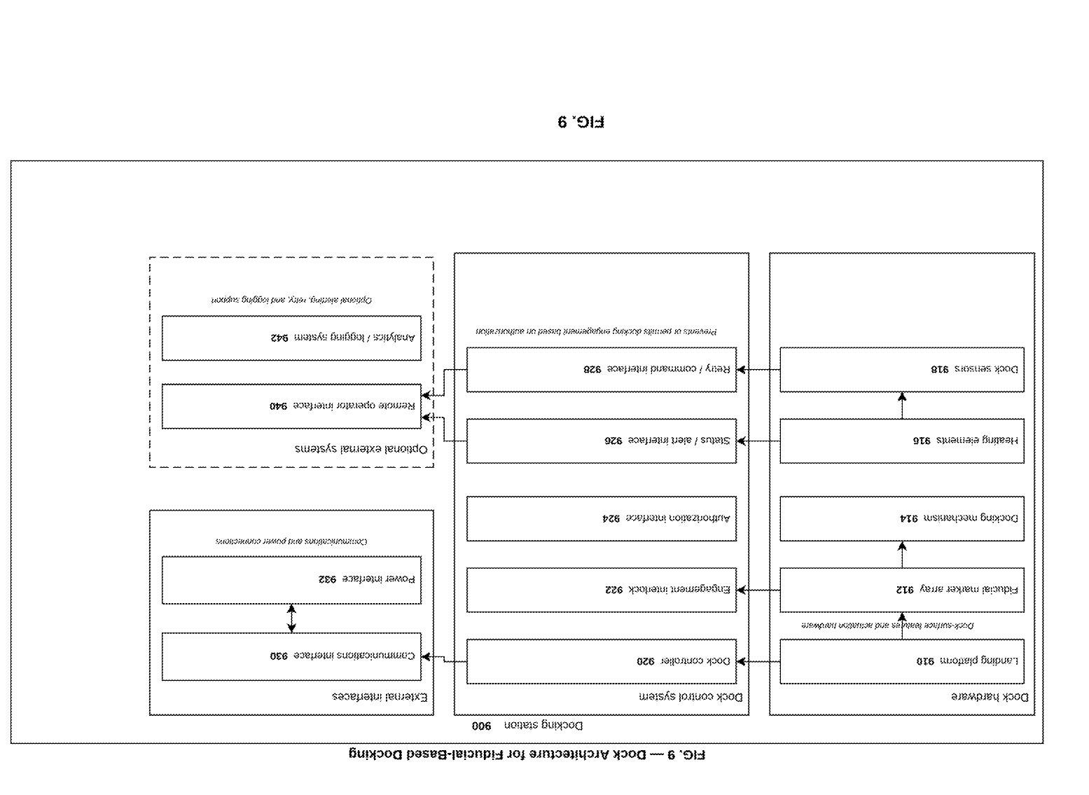

FIG. 9 illustrates an example architecture of a docking station 900 configured to support fiducial-based post-landing verification and controlled docking engagement according to aspects of the present disclosure. Docking station 900 may include components configured to receive a UAV, such as the UAV 100 of FIG. 1, after landing, provide fiducial markers for detection by a navigation camera of the UAV, and control engagement of a docking mechanism based on a post-landing determination of a pose of the UAV.

Docking station 900 may include a landing platform 910 configured to receive a UAV after landing. Landing platform 910 may provide a surface area on which the UAV touches down during docking operations. In some aspects, landing platform 910 may include structural features configured to support the UAV during docking procedures.

Docking station 900 may include a fiducial marker array 912 disposed on or adjacent landing platform 910 to facilitate visual detection and pose estimation by a navigation camera of the UAV. Fiducial marker array 912 may comprise a plurality of fiducial markers configured for machine detection and pose estimation. In some cases, fiducial marker array 912 may include fiducial markers of varying sizes to ensure that at least one fiducial marker is detectable by the navigation camera under different conditions, including varying distances, view angles, and environmental factors.

Docking station 900 may include a docking mechanism 914 configured to engage, secure, align, capture, charge, or otherwise interface with the UAV after landing. In some aspects, docking mechanism 914 may include an alignment mechanism having one or more contact surfaces configured to center and secure the UAV on landing platform 910. In some cases, docking mechanism 914 may include mechanical latches, electromagnets, or magnets configured to secure the UAV to docking station 900.

Docking station 900 may include heating elements 916 configured to improve visibility of fiducial marker array 912. Heating elements 916 may melt snow on fiducial marker array 912 to improve marker visibility. In some cases, heating elements 916 may evaporate water on fiducial marker array 912 to improve marker visibility. Heating elements 916 may activate when snow or water is detected on the landing platform surface, thereby enhancing detection capabilities of the navigation camera under various environmental conditions.

Docking station 900 may include dock sensors 918 configured to detect local dock conditions and support docking operations. Dock sensors 918 may provide information regarding environmental conditions, presence of the UAV, or other parameters associated with docking operations.

Docking station 900 may include a dock control system configured to control operation of docking mechanism 914 and other components of docking station 900. The dock control system may include a dock controller 920 configured to coordinate operation of landing platform 910, fiducial marker array 912, docking mechanism 914, heating elements 916, and dock sensors 918. Dock controller 920 may receive control signals and may generate actuation commands for docking mechanism 914.

The dock control system may include an engagement interlock 922 configured to permit or prevent actuation of docking mechanism 914 based on a received authorization. Engagement interlock 922 may be configured to receive an authorization or inhibit signal corresponding to a post-landing determination of whether the UAV is within acceptable alignment parameters. Engagement interlock 922 may permit actuation of docking mechanism 914 only upon receipt of an engagement authorization signal. In some aspects, engagement interlock 922 may be configured to default to an inhibit state in which actuation of docking mechanism 914 is prevented. In some cases, engagement interlock 922 may comprise a hardware interlock configured to block actuation signals.

The dock control system may include an authorization interface 924 configured to receive an authorization or inhibit signal corresponding to a post-landing determination of whether the UAV is within acceptable alignment parameters. Authorization interface 924 may receive the engagement authorization signal or the engagement inhibit signal from the UAV or from an external system.

The dock control system may include a status / alert interface 926 configured to transmit status information and alerts associated with docking operations. Status / alert interface 926 may transmit alerts when a landing is determined to be unacceptable or when fiducial markers are not detected.

The dock control system may include a retry / command interface 928 configured to receive retry commands or other instructions associated with docking operations. Retry / command interface 928 may receive commands from a remote operator interface in response to an alert indicating an unacceptable landing condition.

Docking station 900 may include a communications interface 930 configured to communicate with the UAV and external systems. Communications interface 930 may transmit and receive signals associated with docking operations, including engagement authorization signals, engagement inhibit signals, status information, and commands.

Docking station 900 may include a power interface 932 configured to provide power to dock components and to the UAV during docking operations. Power interface 932 may supply electrical power to dock controller 920, heating elements 916, dock sensors 918, and other components of docking station 900. In some aspects, power interface 932 may provide charging power to the UAV when the UAV is secured to docking station 900.

Docking station 900 may be coupled to optional external systems including a remote operator interface 940 and an analytics / logging system 942. Remote operator interface 940 may receive alerts and support retry commands when a landing is determined to be unacceptable. Remote operator interface 940 may display status information to an operator and may enable the operator to provide commands for corrective action.

Analytics / logging system 942 may store status, pose-related, and event data associated with docking operations. In some aspects, analytics / logging system 942 may compute post-touchdown sliding distance and direction from pose deltas between frames. Analytics / logging system 942 may determine a change in pose of the UAV between a first time after landing and a second time after landing, and may compute a displacement vector representing the sliding distance and direction. In some cases, analytics / logging system 942 may aggregate slip measurements across flights to tune touchdown aimpoint with an upwind bias. By aggregating slip measurements from multiple landing events, analytics / logging system 942 may identify patterns in post-touchdown sliding behavior and may adjust a target touchdown aimpoint to compensate for wind conditions, thereby improving landing accuracy for subsequent docking operations.

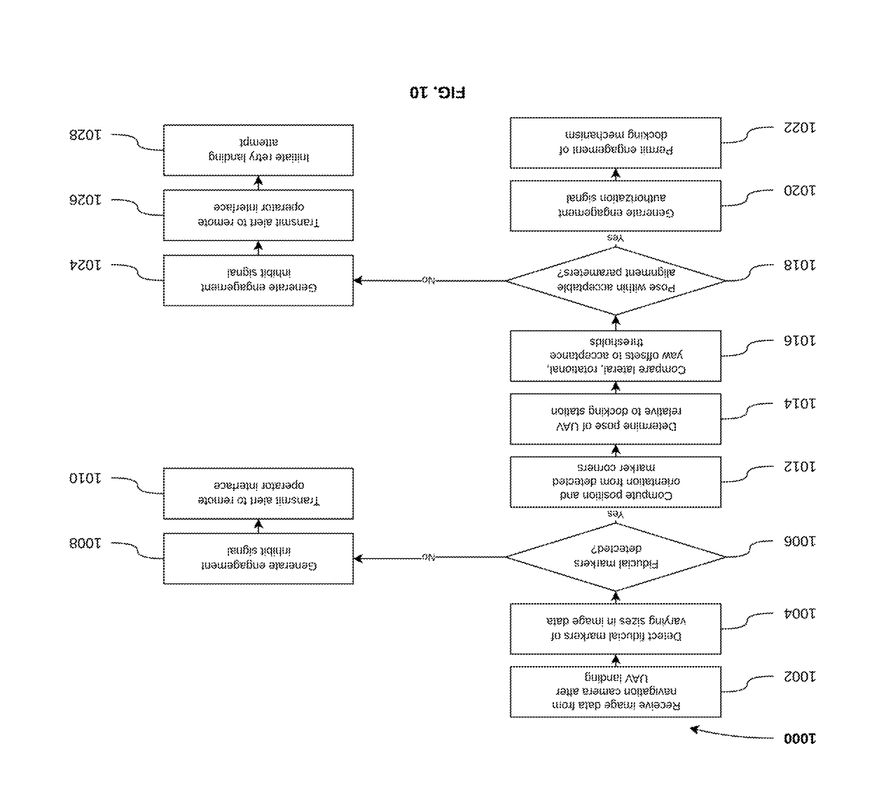

FIG. 10 illustrates a flowchart of a method 1000 for post-landing verification and docking engagement according to aspects of the present disclosure. Method 1000 may be performed by a post-landing visual confirmation system of a UAV after the UAV has landed on a docking station.

Method 1000 may begin at a step 1002 where image data is received from a navigation camera after UAV landing. The navigation camera may capture image data of a fiducial marker array disposed on a landing platform of the docking station. The image data may be received by a post-landing visual confirmation system for processing.

At a step 1004, fiducial markers of varying sizes may be detected in the image data. The post-landing visual confirmation system 115 may process the image data to identify one or more fiducial markers of the fiducial marker array. The fiducial marker array may comprise fiducial markers of varying sizes to ensure that at least one fiducial marker is detectable under different conditions.

At a step 1006, a determination may be made whether fiducial markers are detected. The post-landing visual confirmation system may evaluate whether one or more fiducial markers have been successfully identified in the image data.

When fiducial markers are not detected at step 1006, method 1000 may proceed along a negative branch. At a step 1008, an engagement inhibit signal may be generated. The post-landing visual confirmation system may generate the engagement inhibit signal to prevent engagement of a docking mechanism when fiducial markers are not detected in the image data.

At a step 1010, an alert may be transmitted to a remote operator interface. The post-landing visual confirmation system may transmit the alert to notify an operator that fiducial markers were not detected and that engagement of the docking mechanism has been inhibited.

When fiducial markers are detected at step 1006, method 1000 may proceed along an affirmative branch. At a step 1012, a position and orientation may be computed from detected marker corners. The post-landing visual confirmation system may compute a relative position and orientation of the UAV with respect to the docking station based on detected corners of the one or more fiducial markers.

At a step 1014, a pose of the UAV relative to the docking station may be determined. The post-landing visual confirmation system may determine the pose based on the computed position and orientation. The pose may include translational and rotational components representing the spatial relationship between the UAV and the docking station.

At a step 1016, lateral, rotational, and yaw offsets may be compared to acceptance thresholds. The post-landing visual confirmation system may compare at least one of a lateral offset, a rotational offset, or a yaw offset to a corresponding acceptance threshold to determine whether the pose is within acceptable alignment parameters.

At a step 1018, a determination may be made whether the pose is within acceptable alignment parameters. The post-landing visual confirmation system may evaluate whether the compared offsets satisfy the acceptance thresholds. In some embodiments, a determination of geometric conditions such as whether the UAV 100 is positioned within an engagement region associated with the docking mechanism 145 is made.

When the pose is within acceptable parameters at step 1018 or the UAV 100 is positioned within the engagement region, method 1000 may proceed along an affirmative branch. At a step 1020, an engagement authorization signal may be generated. The post-landing visual confirmation system may generate the engagement authorization signal to permit engagement of the docking mechanism when the pose is within the acceptable alignment parameters.

At a step 1022, engagement of the docking mechanism may be permitted. The docking mechanism may be actuated to secure, align, charge, or otherwise interface with the UAV after landing.

When the pose is not within acceptable parameters at step 1018 or the UAV 100 is not positioned within the engagement region, method 1000 may proceed along a negative branch. At a step 1024, an engagement inhibit signal may be generated. The post-landing visual confirmation system may generate the engagement inhibit signal to prevent engagement of the docking mechanism when the pose is not within the acceptable alignment parameters.

At a step 1026, an alert may be transmitted to a remote operator interface. The post-landing visual confirmation system may transmit the alert to notify an operator of the misaligned landing condition and may enable the operator to provide commands for corrective action.

At a step 1028, a retry landing attempt may be initiated. The post-landing visual confirmation system may command the UAV to take off from the landing platform and attempt landing again. In some aspects, the retry landing attempt may be automated. In some cases, the retry landing attempt may be initiated in response to an operator command received via the remote operator interface.

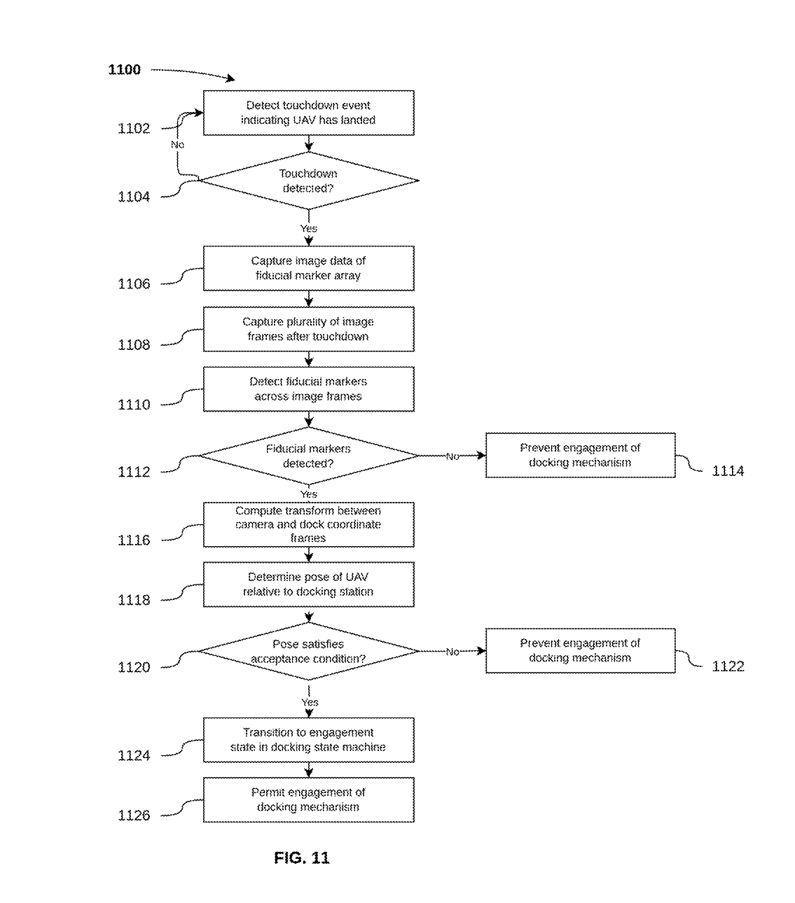

FIG. 11 illustrates a flowchart of a method 1100 for controlled docking after touchdown detection according to aspects of the present disclosure. Method 1100 may be performed by a post-landing visual confirmation system to control engagement of a docking mechanism based on detection of a touchdown event and subsequent pose verification.

Method 1100 may begin at a step 1102 where a touchdown event indicating the UAV has landed is detected. The touchdown event may be detected based on an inertial measurement unit signature, motor state changes, a contact sensor, or vision-based detection using changes in a camera view.

At a step 1104, a determination may be made whether the touchdown is detected. The system may evaluate whether a touchdown event has been successfully identified.

When the touchdown is not detected at step 1104, method 1100 may loop back to step 1102 to continue monitoring for a touchdown event. The system may continue monitoring until a touchdown event is detected.

When the touchdown is detected at step 1104, method 1100 may proceed along an affirmative branch. At a step 1106, image data of the fiducial marker array may be captured. The navigation camera may capture image data of the fiducial marker array disposed on the landing platform after the touchdown event is detected.

At a step 1108, a plurality of image frames may be captured after touchdown. The navigation camera may capture multiple image frames to support detection and pose estimation. In some aspects, capturing the plurality of image frames may occur within a predefined time window after landing.

At a step 1110, fiducial markers may be detected across the image frames. The post-landing visual confirmation system may process the plurality of image frames to detect one or more fiducial markers of the fiducial marker array across the frames.

At a step 1112, a determination may be made whether fiducial markers are detected. The post-landing visual confirmation system may evaluate whether one or more fiducial markers have been successfully identified in the image frames.

When fiducial markers are not detected at step 1112, method 1100 may proceed along a negative branch. At a step 1114, engagement of the docking mechanism may be prevented. The post-landing visual confirmation system may generate an engagement inhibit signal to prevent actuation of the docking mechanism when fiducial markers are not detected after the touchdown event.

When fiducial markers are detected at step 1112, method 1100 may proceed along an affirmative branch. At a step 1116, a transform may be computed between camera and dock coordinate frames. The post-landing visual confirmation system may compute a transform between a camera coordinate frame and a docking station coordinate frame based on the detected fiducial markers.

At a step 1118, a pose of the UAV relative to the docking station may be determined. The post-landing visual confirmation system may determine the pose based on the computed transform. The pose may represent the position and orientation of the UAV with respect to the docking station.

At a step 1120, a determination may be made whether the pose satisfies an acceptance condition. The post-landing visual confirmation system may evaluate whether the determined pose is within acceptable alignment parameters for engagement of the docking mechanism.

When the pose does not satisfy the acceptance condition at step 1120, method 1100 may proceed along a negative branch. At a step 1122, engagement of the docking mechanism may be prevented. The post-landing visual confirmation system may generate an engagement inhibit signal to prevent actuation of the docking mechanism when the pose is not within acceptable alignment parameters.

When the pose satisfies the acceptance condition at step 1120, method 1100 may proceed along an affirmative branch. At a step 1124, a transition to an engagement state in a docking state machine may occur. The system may transition from a landing evaluation state to an engagement state in which actuation of the docking mechanism is permitted.

At a step 1126, engagement of the docking mechanism may be permitted. The docking mechanism may be actuated to secure, align, charge, or otherwise interface with the UAV after landing.

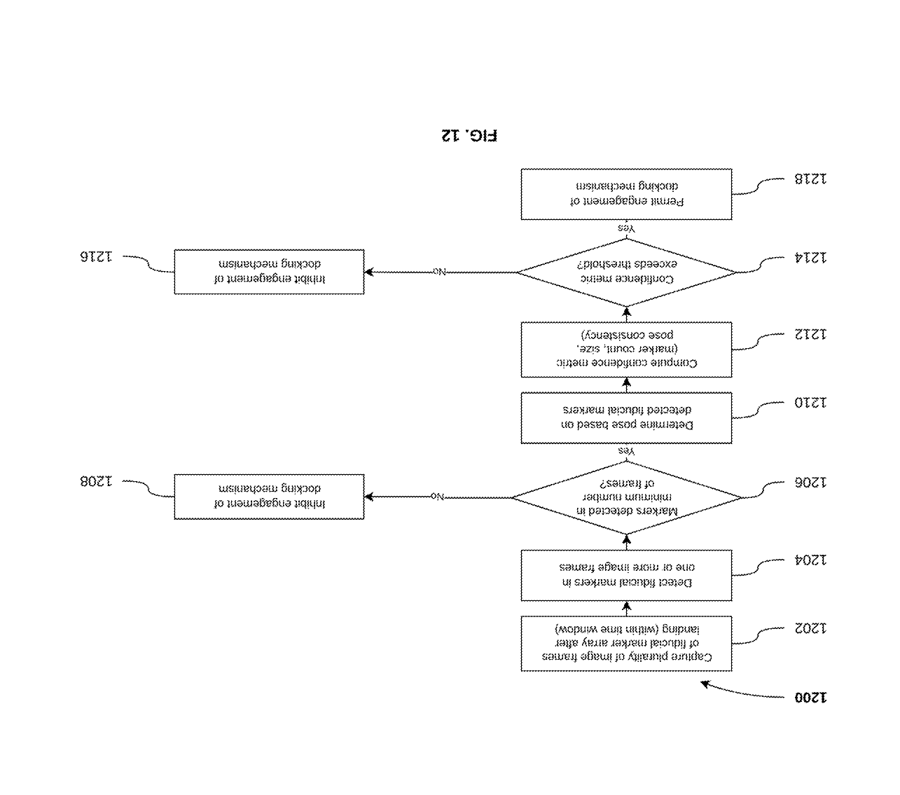

FIG. 12 illustrates a flowchart of a method 1200 for confidence-based landing verification according to aspects of the present disclosure. Method 1200 may be performed by a post-landing visual confirmation system to verify a landing condition based on a confidence metric associated with pose estimation.

Method 1200 may begin at a step 1202 where a plurality of image frames of a fiducial marker array are captured after landing within a predefined time window. The navigation camera may capture multiple image frames after the UAV has landed on the landing platform. The predefined time window may specify a duration after touchdown during which image frames are captured for pose verification.

At a step 1204, fiducial markers may be detected in one or more of the image frames. The post-landing visual confirmation system may process the image frames to identify fiducial markers of the fiducial marker array.

At a step 1206, a determination may be made whether markers are detected in a minimum number of frames. The post-landing visual confirmation system may evaluate whether fiducial markers have been detected in at least a minimum number of the captured image frames.

When markers are not detected in the minimum number of frames at step 1206, method 1200 may proceed along a negative branch. At a step 1208, engagement of the docking mechanism may be inhibited. The post-landing visual confirmation system may generate an engagement inhibit signal to prevent actuation of the docking mechanism when the minimum detection threshold is not met.

When markers are detected in the minimum number of frames at step 1206, method 1200 may proceed along an affirmative branch. At a step 1210, a pose may be determined based on detected fiducial markers. The post-landing visual confirmation system may determine a pose of the UAV relative to the docking station based on the detected fiducial markers.

At a step 1212, a confidence metric may be computed based on marker count, marker size, and pose consistency across frames. The confidence metric may be based on a number of detected fiducial markers, a size of detected fiducial markers in the image frames, and consistency of pose estimates across frames. In some aspects, the confidence metric may weight these factors to produce an overall confidence score.

At a step 1214, a determination may be made whether the confidence metric exceeds a threshold. The post-landing visual confirmation system may compare the computed confidence metric to a confidence threshold to determine whether the pose estimation is sufficiently reliable for engagement of the docking mechanism.

When the confidence metric does not exceed the threshold at step 1214, method 1200 may proceed along a negative branch. At a step 1216, engagement of the docking mechanism may be inhibited. The post-landing visual confirmation system may generate an engagement inhibit signal to prevent actuation of the docking mechanism when the confidence metric does not exceed the threshold.

When the confidence metric exceeds the threshold at step 1214, method 1200 may proceed along an affirmative branch. At a step 1218, engagement of the docking mechanism may be permitted. The post-landing visual confirmation system may generate an engagement authorization signal to permit actuation of the docking mechanism when the confidence metric exceeds the threshold.

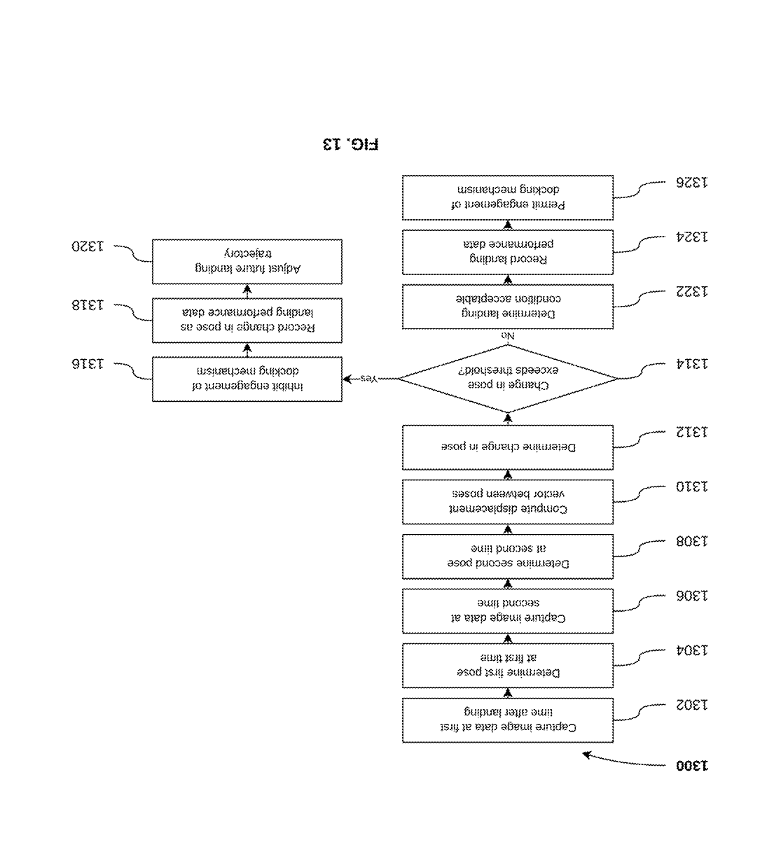

FIG. 13 illustrates a flowchart of a method 1300 for pose-change evaluation of a landing condition according to aspects of the present disclosure. Method 1300 may be performed by a post-landing visual confirmation system to evaluate a landing condition based on a change in pose of the UAV after landing.

Method 1300 may begin at a step 1302 where image data is captured at a first time after landing. The navigation camera may capture image data of the fiducial marker array at the first time after the UAV has landed on the landing platform.

At a step 1304, a first pose may be determined at the first time. The post-landing visual confirmation system may determine the first pose of the UAV relative to the docking station based on fiducial markers detected in the image data captured at the first time.

At a step 1306, image data may be captured at a second time. The navigation camera may capture image data of the fiducial marker array at the second time after landing. In some aspects, the first time and the second time may comprise consecutive image frames after landing.

At a step 1308, a second pose may be determined at the second time. The post-landing visual confirmation system may determine the second pose of the UAV relative to the docking station based on fiducial markers detected in the image data captured at the second time.

At a step 1310, a displacement vector may be computed between the first and second poses. The post-landing visual confirmation system may compute the displacement vector representing a change in position and orientation between the first pose and the second pose.

At a step 1312, a change in pose may be determined. The post-landing visual confirmation system may determine the change in pose based on the computed displacement vector. The change in pose may correspond to a sliding motion of the UAV on the landing platform.

At a step 1314, a determination may be made whether the change in pose exceeds a threshold. The post-landing visual confirmation system may compare the change in pose to a threshold to determine whether the UAV has moved excessively after landing.

When the change in pose exceeds the threshold at step 1314, method 1300 may proceed along an affirmative branch. At a step 1316, engagement of the docking mechanism may be inhibited. The post-landing visual confirmation system may generate an engagement inhibit signal to prevent actuation of the docking mechanism when the change in pose exceeds the threshold.

At a step 1318, the change in pose may be recorded as landing performance data. The post-landing visual confirmation system may record the change in pose for analysis and fleet tuning purposes. In some aspects, the landing performance data may be transmitted to an analytics / logging system.

At a step 1320, a future landing trajectory may be adjusted based on the change in pose. The system may adjust a target touchdown aimpoint or landing trajectory for subsequent landing attempts based on the recorded change in pose. In some cases, the adjustment may include an upwind bias to compensate for wind conditions that contributed to the post-landing sliding.

When the change in pose does not exceed the threshold at step 1314, method 1300 may proceed along a negative branch. At a step 1322, the landing condition may be determined to be acceptable. The post-landing visual confirmation system may determine that the UAV has not moved excessively after landing and that the landing condition is acceptable for engagement of the docking mechanism.

At a step 1324, landing performance data may be recorded. The post-landing visual confirmation system may record the change in pose and other landing metrics for analysis purposes, even when the landing condition is determined to be acceptable.

At a step 1326, engagement of the docking mechanism may be permitted. The post-landing visual confirmation system may generate an engagement authorization signal to permit actuation of the docking mechanism when the change in pose does not exceed the threshold and the landing condition is determined to be acceptable.

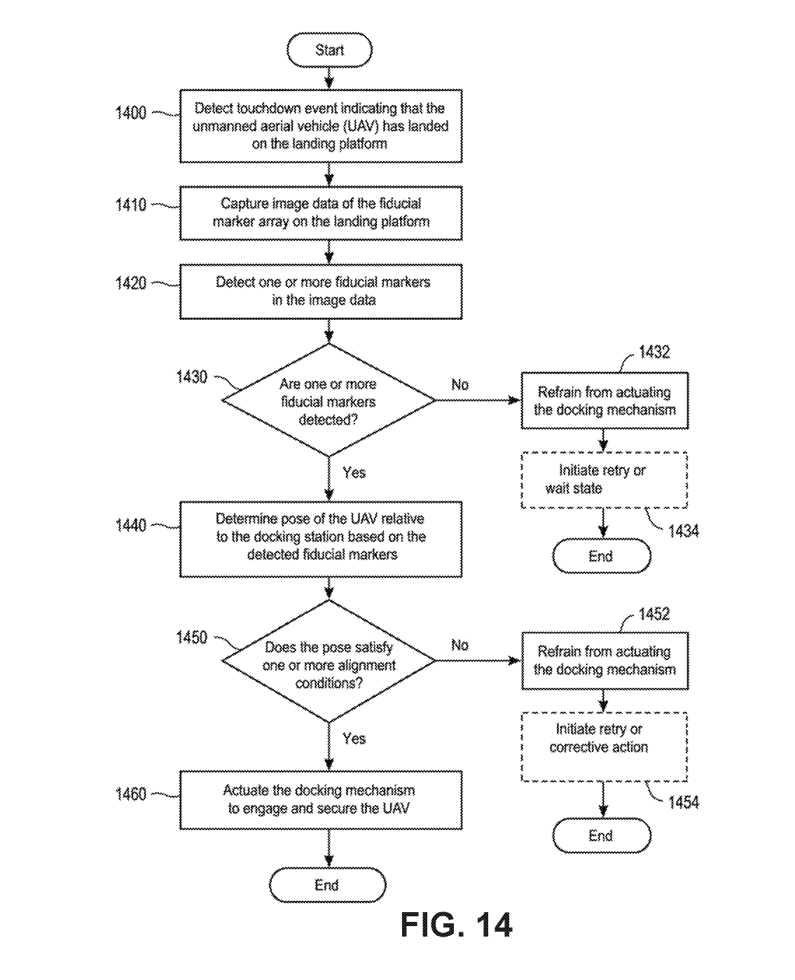

Referring to FIG. 14, a method for docking a UAV at a docking station is illustrated. The method may be performed by one or more processors of the UAV 100, the docking station 130, or a combination thereof. The onboard compute system of the UAV 100 may include one or more processors configured to implement the post-landing visual confirmation system, fiducial detection, pose estimation, and docking decision logic.

At block 1400, a touchdown event is detected. The touchdown event indicates that a UAV (e.g., the UAV 100) has landed on a landing platform 135 of the docking station 130. The touchdown event may be determined based on one or more signals, including inertial measurements, motor state transitions, contact sensors, or other landing detection mechanisms.

At block 1410, image data of a fiducial marker array 140 associated with the landing platform 135 is captured using a navigation camera 105 of the UAV 100. In some aspects, the image data may include a plurality of image frames captured over a period of time following the touchdown event.

At block 1420, one or more fiducial markers are detected in the image data. Detection may include identifying marker patterns, decoding marker identifiers, or otherwise extracting positional information from the fiducial markers.

At decision block 1430, a determination is made as to whether one or more fiducial markers are detected. When fiducial markers are not detected, the method proceeds to block 1432, where actuation of a docking mechanism 145 is prevented. For example, the UAV 100 may generate an engagement inhibit signal to prevent engagement of the docking mechanism. In some aspects, the system may optionally proceed to block 1434 to initiate a retry of the landing, wait state, or other recovery action, such as capturing additional image data or repositioning the UAV 100.

When fiducial markers are detected, the method proceeds to block 1440, where a pose of the UAV 100 relative to the docking station 130 is determined based on the detected fiducial markers. The pose may include one or more of a position and an orientation of the UAV 100 relative to a coordinate frame of the docking station 130.

At decision block 1450, a determination is made as to whether the pose satisfies one or more alignment conditions. As described herein, the alignment conditions may include criteria based on alignment parameters, such as whether lateral offset, rotational offset, yaw offset, or other alignment metrics are within corresponding thresholds, or may include geometric conditions such as whether the UAV 100 is positioned within an engagement region associated with the docking mechanism 145.

When the pose does not satisfy the alignment conditions, the method proceeds to block 1452, where actuation of the docking mechanism 145 is prevented. In some aspects, the method may optionally proceed to block 1454 to initiate a retry of the landing of the UAV 100, corrective action, or other mitigation, such as commanding the UAV 100 to adjust position or perform a subsequent landing attempt.

When the pose satisfies the alignment conditions, the method proceeds to block 1460, where the docking mechanism 145 is actuated to engage the UAV 100. Actuation of the docking mechanism may include initiating mechanical movement of one or more components, such as contact surfaces, alignment structures, or retention elements, to secure, align, or otherwise interface with the UAV 100.

In some aspects, subsequent operations may be performed following engagement, such as charging the UAV 100, establishing a communication link, or performing post-docking diagnostics.

It should be understood that the sequence of operations illustrated in FIG. 14, or in the flowcharts of other figures, is provided for purposes of illustration, and that in some embodiments one or more operations may be omitted, combined, or performed in a different order. For example, detection of fiducial markers and determination of pose may be performed iteratively across multiple image frames, and determinations at decision blocks 1430 and 1450 may be based on aggregated or confidence-weighted data.

A number of implementations have been described. Nevertheless, it will be understood that various modifications may be made without departing from the spirit and scope of the disclosure. Accordingly, other implementations are within the scope of the following claims.

The present techniques will be better understood with reference to the following enumerated embodiments.

Clause 1. A system for drone docking, the system comprising: a docking station comprising: a landing platform configured to receive an unmanned aerial vehicle; and a fiducial marker array disposed on the landing platform, the fiducial marker array comprising a plurality of fiducial markers; a docking mechanism configured to engage the unmanned aerial vehicle when the unmanned aerial vehicle is positioned on the landing platform; a navigation camera mounted on the unmanned aerial vehicle and configured to capture image data of the fiducial marker array after the unmanned aerial vehicle has landed on the landing platform; and a post-landing visual confirmation system configured to: detect one or more fiducial markers of the fiducial marker array in the image data captured by the navigation camera; determine a pose of the unmanned aerial vehicle relative to the docking station based on the detected one or more fiducial markers; determine whether the pose is within acceptable alignment parameters; and generate an engagement authorization signal to permit engagement of the docking mechanism when the pose is within the acceptable alignment parameters.

Clause 2. The system of clause 1, wherein the post-landing visual confirmation system is further configured to generate an engagement inhibit signal to prevent engagement of the docking mechanism when the pose is not within the acceptable alignment parameters.

Clause 3. The system of clause 2, wherein the post-landing visual confirmation system is further configured to generate an engagement inhibit signal to prevent engagement of the docking mechanism when the one or more fiducial markers are not detected in the image data.

Clause 4. The system of clause 1, wherein the fiducial marker array comprises fiducial markers of varying sizes, wherein the varying sizes ensure that at least one fiducial marker is detectable by the navigation camera under different conditions.

Clause 5. The system of clause 1, wherein the docking station further comprises an alignment mechanism configured to center and secure the unmanned aerial vehicle on the landing platform, and wherein the engagement authorization signal permits actuation of the alignment mechanism.

Clause 6. The system of clause 1, further comprising a communications interface configured to transmit an alert message to a remote operator interface when the pose is not within the acceptable alignment parameters.

Clause 7. The system of clause 1, wherein the post-landing visual confirmation system is further configured to initiate a retry landing attempt when the pose is not within the acceptable alignment parameters.

Clause 8. The system of clause 1, wherein the docking station further comprises heating elements configured to improve visibility of the fiducial marker array by melting snow or evaporating water from the landing platform.

Clause 9. A method for post-landing verification and docking engagement, the method comprising: receiving, by a post-landing visual confirmation system, image data captured by a navigation camera mounted on an unmanned aerial vehicle after the unmanned aerial vehicle has landed on a landing platform of a docking station, wherein the landing platform comprises a fiducial marker array; detecting, by the post-landing visual confirmation system, one or more fiducial markers of the fiducial marker array in the image data; determining, by the post-landing visual confirmation system, a pose of the unmanned aerial vehicle relative to the docking station based on the detected one or more fiducial markers; determining, by the post-landing visual confirmation system, whether the pose is within acceptable alignment parameters; and generating, by the post-landing visual confirmation system, an engagement authorization signal to permit engagement of a docking mechanism when the pose is within the acceptable alignment parameters.

Clause 10. The method of clause 9, further comprising generating an engagement inhibit signal to prevent engagement of the docking mechanism when the pose is not within the acceptable alignment parameters.

Clause 11. The method of clause 9, further comprising generating an engagement inhibit signal to prevent engagement of the docking mechanism when the one or more fiducial markers are not detected in the image data.

Clause 12. The method of clause 9, wherein the fiducial marker array comprises fiducial markers of varying sizes, and wherein detecting the one or more fiducial markers comprises detecting at least one fiducial marker of the fiducial markers of varying sizes.

Clause 13. The method of clause 9, further comprising transmitting an alert message to a remote operator interface when the pose is not within the acceptable alignment parameters.

Clause 14. The method of clause 9, further comprising initiating a retry landing attempt when the pose is not within the acceptable alignment parameters, wherein initiating the retry landing attempt comprises commanding the unmanned aerial vehicle to take off from the landing platform and attempt landing again.

Clause 15. The method of clause 9, wherein determining the pose comprises computing a relative position and orientation of the unmanned aerial vehicle with respect to the docking station based on detected corners of the one or more fiducial markers.

Clause 16. The method of clause 9, wherein determining whether the pose is within acceptable alignment parameters comprises comparing at least one of a lateral offset, a rotational offset, or a yaw offset to a corresponding acceptance threshold.

Clause 17. A non-transitory computer-readable medium storing instructions that, when executed by a processor of an unmanned aerial vehicle, cause the processor to: receive image data captured by a navigation camera mounted on the unmanned aerial vehicle after the unmanned aerial vehicle has landed on a landing platform of a docking station, wherein the landing platform comprises a fiducial marker array; detect one or more fiducial markers of the fiducial marker array in the image data; determine a pose of the unmanned aerial vehicle relative to the docking station based on the detected one or more fiducial markers; determine whether the pose is within acceptable alignment parameters; and generate an engagement authorization signal to permit engagement of a docking mechanism of the docking station when the pose is within the acceptable alignment parameters.

Clause 18. The non-transitory computer-readable medium of clause 17, wherein the instructions further cause the processor to generate an engagement inhibit signal to prevent engagement of the docking mechanism when the pose is not within the acceptable alignment parameters or when the one or more fiducial markers are not detected in the image data.

Clause 19. The non-transitory computer-readable medium of clause 17, wherein the instructions further cause the processor to transmit an alert message to a remote operator interface and initiate a retry landing attempt when the pose is not within the acceptable alignment parameters.

Clause 20. The non-transitory computer-readable medium of clause 17, wherein the fiducial marker array comprises fiducial markers of varying sizes to ensure that at least one fiducial marker is detectable by the navigation camera across different distances and view angles.

Clause 21. A docking station configured for controlled engagement of an unmanned aerial vehicle, the docking station comprising: a docking mechanism configured to engage the unmanned aerial vehicle; and an engagement interlock configured to: receive an engagement authorization signal generated based on a post-landing determination of a pose of the unmanned aerial vehicle; and prevent actuation of the docking mechanism in the absence of the engagement authorization signal.

Clause 22. The docking station of clause 21, wherein the engagement interlock permits actuation of the docking mechanism only upon receipt of the engagement authorization signal.

Clause 23. The docking station of clause 21, wherein the engagement interlock is configured to default to an inhibit state in which actuation of the docking mechanism is prevented.

Clause 24. The docking station of clause 21, further comprising a dock controller configured to control the docking mechanism, wherein the engagement interlock is positioned between the dock controller and the docking mechanism.

Clause 25. The docking station of clause 21, wherein the engagement interlock comprises a hardware interlock configured to block actuation signals.

Clause 26. The docking station of clause 21, wherein the engagement interlock is configured to inhibit actuation when a detection confidence associated with fiducial detection is below a threshold.

Clause 27. The docking station of clause 21, wherein the engagement interlock prevents actuation when fiducial markers are not detected.

Clause 28. A method for controlling docking of an unmanned aerial vehicle, the method comprising: detecting a touchdown event indicating that the unmanned aerial vehicle has landed on a docking station; after detecting the touchdown event, capturing image data of a fiducial marker array disposed on the docking station; detecting one or more fiducial markers in the image data; determining a pose of the unmanned aerial vehicle relative to the docking station based on the detected fiducial markers; and permitting engagement of a docking mechanism only after determining that the pose satisfies an acceptance condition.

Clause 29. The method of clause 28, wherein capturing the image data occurs after the touchdown event is detected.

Clause 30. The method of clause 28, further comprising preventing engagement of the docking mechanism when the fiducial markers are not detected after the touchdown event.

Clause 31. The method of clause 28, wherein determining the pose comprises computing a transform between a camera coordinate frame and a docking station coordinate frame.

Clause 32. The method of clause 28, further comprising capturing a plurality of image frames after the touchdown event and detecting fiducial markers across the plurality of image frames.

Clause 33. The method of clause 28, wherein permitting engagement comprises transitioning to an engagement state in a docking state machine.

Clause 34. A system for controlling docking of an unmanned aerial vehicle, the system comprising: a docking station including an alignment mechanism having one or more contact surfaces; and a processor configured to: determine a pose of the unmanned aerial vehicle relative to the docking station; determine whether at least a portion of the unmanned aerial vehicle is positioned within an engagement region corresponding to the one or more contact surfaces; and permit engagement of the alignment mechanism only when the unmanned aerial vehicle is positioned within the engagement region.

Clause 35. The system of clause 34, wherein the engagement region corresponds to a region in which the one or more contact surfaces are configured to contact landing legs of the unmanned aerial vehicle.

Clause 36. The system of clause 34, wherein the engagement region comprises a plurality of subregions corresponding to respective landing interfaces of the unmanned aerial vehicle.

Clause 37. The system of clause 34, wherein determining whether the unmanned aerial vehicle is within the engagement region comprises evaluating at least one of a lateral offset or a rotational offset.

Clause 38. The system of clause 34, wherein engagement is inhibited when any portion of the unmanned aerial vehicle lies outside the engagement region.

Clause 39. The system of clause 34, wherein the engagement region is defined based on geometric constraints of the alignment mechanism.

Clause 40. The system of clause 34, wherein the engagement region includes a tolerance region adjacent to a contact surface.

Clause 41. A method for verifying a landing condition of an unmanned aerial vehicle, the method comprising: capturing a plurality of image frames of a fiducial marker array after landing; detecting fiducial markers in one or more of the plurality of image frames; determining a pose of the unmanned aerial vehicle based on the detected fiducial markers; computing a confidence metric associated with the pose; and permitting engagement of a docking mechanism when the confidence metric exceeds a threshold.

Clause 42. The method of clause 41, wherein detecting fiducial markers comprises detecting fiducial markers in at least a minimum number of frames.

Clause 43. The method of clause 41, wherein the confidence metric is based on a number of detected fiducial markers.

Clause 44. The method of clause 41, wherein the confidence metric is based on a size of detected fiducial markers in the image frames.

Clause 45. The method of clause 41, wherein the confidence metric is based on consistency of pose estimates across frames.

Clause 46. The method of clause 41, further comprising inhibiting engagement when the confidence metric does not exceed the threshold.

Clause 47. The method of clause 41, wherein capturing the plurality of image frames occurs within a predefined time window after landing.

Clause 48. A method for evaluating a landing condition of an unmanned aerial vehicle, the method comprising: capturing image data of a fiducial marker array at a plurality of times after landing; determining a first pose of the unmanned aerial vehicle at a first time and a second pose at a second time; determining a change in pose between the first pose and the second pose; and determining whether the landing condition is acceptable based on the change in pose.

Clause 49. The method of clause 48, wherein the change in pose corresponds to a sliding motion of the unmanned aerial vehicle on a landing platform.

Clause 50. The method of clause 48, further comprising inhibiting engagement of a docking mechanism when the change in pose exceeds a threshold.

Clause 51. The method of clause 48, further comprising recording the change in pose as landing performance data.

Clause 52. The method of clause 48, further comprising adjusting a future landing trajectory based on the change in pose.

Clause 53. The method of clause 48, wherein determining the change in pose comprises computing a displacement vector.

Clause 54. The method of clause 48, wherein the plurality of times comprise consecutive image frames after landing.

1. A system for docking an unmanned aerial vehicle (UAV), comprising:
a docking station having:
a landing platform configured to receive a UAV,
a fiducial marker array disposed on the landing platform, and
a docking mechanism configured to engage the UAV; and
a processor of the UAV, wherein the processor is configured to, in response to a touchdown event indicating that the UAV has landed on the landing platform:
capture image data of the fiducial marker array using a navigation camera of the UAV;
detect one or more fiducial markers in the image data;
determine a pose of the UAV relative to the docking station based on the detected one or more fiducial markers;
determine whether the pose satisfies one or more alignment conditions; and
control actuation of the docking mechanism based on the pose by: actuating the docking mechanism to engage the UAV when the pose satisfies the one or more alignment conditions and refraining from actuating when the pose does not satisfy the one or more alignment conditions or when the one or more fiducial markers are not detected.

2. The system of claim 1, wherein the processor is configured to:
capture a plurality of image frames after the touchdown event,
detect the one or more fiducial markers across the plurality of image frames, and
determine that the one or more fiducial markers are not detected based on a failure to detect fiducial markers across the plurality of image frames.

3. The system of claim 2, wherein the processor is configured to:
determine a confidence metric associated with the detected one or more fiducial markers based on at least one of (a) a number of detected fiducial markers, (b) a size of the detected fiducial markers in the image frames, or (c) consistency of pose estimates across the plurality of image frames, and
actuate the docking mechanism when the confidence metric exceeds a threshold.

4. The system of claim 1, wherein the processor is configured to determine whether the pose satisfies the one or more alignment conditions by evaluating at least one of a lateral offset or a rotational offset of the UAV relative to the docking station.

5. The system of claim 4, wherein the processor is configured to evaluate by comparing the at least one of the lateral offset or the rotational offset to one or more predefined thresholds.

6. The system of claim 1, wherein the fiducial marker array comprises fiducial markers of different sizes.

7. The system of claim 6, wherein the fiducial markers of different sizes are arranged such that at least one fiducial marker is detectable across different distances or viewing angles of the navigation camera.

8. The system of claim 1, wherein the processor is configured to initiate a retry landing attempt when the pose does not satisfy the one or more alignment conditions.

9. The system of claim 8, wherein the process is configured to initiate the retry landing attempt by commanding the UAV to take off from the landing platform and attempt landing again.

10. The system of claim 1 further comprising:
a communication interface configured to transmit an alert indicating that the pose does not satisfy the one or more alignment conditions.

11. The system of claim 1, wherein the docking station comprises:
an engagement interlock configured to prevent actuation of the docking mechanism in the absence of a determination that the pose satisfies the one or more alignment conditions.

12. The system of claim 11, wherein the engagement interlock is configured to default to an inhibit state.

13. The system of claim 11, wherein the engagement interlock comprises a hardware interlock configured to block actuation of the docking mechanism.

14. A system for docking an unmanned aerial vehicle (UAV), comprising:
a docking station having a landing platform and a docking mechanism comprising an alignment mechanism having one or more contact surfaces configured to engage the UAV; and
at least one processor configured to:
determine, after a touchdown event, a pose of the UAV relative to the docking station based on image data of a fiducial marker array associated with the landing platform;
determine whether the UAV is positioned within an engagement region defined relative to the one or more contact surfaces; and
actuate the docking mechanism to engage the UAV when the UAV is positioned within the engagement region and refrain from actuating the docking mechanism when the UAV is not positioned within the engagement region.

15. The system of claim 14, wherein the engagement region corresponds to positions in which the one or more contact surfaces are configured to contact landing interfaces of the UAV.

16. The system of claim 14, wherein the engagement region includes a tolerance region defined relative to the one or more contact surfaces.

17. A method for docking an unmanned aerial vehicle (UAV) at a docking station, the method comprising:
detecting a touchdown event indicating that the UAV has landed on a landing platform of the docking station;
capturing, using a navigation camera of the UAV, image data of a fiducial marker array associated with the landing platform;
detecting one or more fiducial markers in the image data;
determining a pose of the UAV relative to the docking station based on the detected one or more fiducial markers;
evaluating the pose against one or more alignment conditions; and
actuating a docking mechanism of the docking station to engage the UAV when the pose satisfies the one or more alignment conditions and refraining from actuating the docking mechanism when the pose does not satisfy the one or more alignment conditions or when the one or more fiducial markers are not detected.

18. The method of claim 17, wherein detecting the one or more fiducial markers comprises:
capturing a plurality of image frames after the touchdown event and detecting the one or more fiducial markers across the plurality of image frames.

19. The method of claim 17 further comprising:
determining a confidence metric associated with the pose; and
actuating the docking mechanism when the confidence metric exceeds a threshold.

20. The method of claim 17 further comprising:
determining a change in pose of the UAV after the touchdown event based on image data captured at a plurality of times; and
refraining from actuating the docking mechanism when the change in pose exceeds a threshold.
